(19) United States
(12) Patent Application Publication
(10) Pub. No.: US 2024/0185545 A1
(43) Pub. Date: Jun. 6, 2024

(54) DISPLAY CONTROL DEVICE, DISPLAY CONTROL METHOD, AND PROGRAM

(71) Applicant: SONY GROUP CORPORATION, TOKYO (JP)

(72) Inventor: TOMU TAHARA, TOKYO (JP)

(21) Appl. No.: 18/554,000

(22) PCT Filed: Jan. 28, 2022
(86) PCT No.: PCT/JP2022/003252

§ 371 Date: Oct. 5, 2023

(30) Foreign Application Priority Data
Apr. 21, 2021 (JP) 2021-071588

(51) Int. Cl. G06T 19/00; G06F 3/147; G06V 20/20

(52) U.S. Cl. CPC G06T 19/006; G06F 3/147; G06V 20/20; G06T 2210/61

(57) ABSTRACT

The present technology relates to a display control device, a display control method, and a program that enable virtual content to be arranged in more diverse environments. A display control device according to one aspect of the present technology controls output of an output device to perform arrangement control of arranging a virtual object on a real space when suitability of a first combination of a plurality of real space nodes and real space edges and a second combination of a plurality of template nodes and template edges is a first suitability, and to perform display control related to arrangement of the virtual object when suitability is a second suitability lower than the first suitability. The present technology can be applied to, for example, a transmissive HMD.

### TECHNICAL FIELD

The present technology particularly relates to a display control device, a display control method, and a program capable of arranging virtual content in more diverse environments.

### BACKGROUND ART

The display of virtual content created assuming a predetermined environment is performed in consideration of geometric information and semantic information of a target environment. Specifically, the virtual content such as a character is displayed in superposition with the real space in consideration of the context of the space constituted by the shape, number, arrangement, attribute, and relationship of objects, and the like.

A user wearing a display device such as a head mounted display (HMD) can obtain an experience as if a character is in the same space as the space where the user is.

Non-Patent Document 1 discloses a technique of constructing a three-dimensional scene graph representing a context of a space in an abstract manner on the basis of a three-dimensional map having geometric and semantic information of the space. The virtual content can be arranged by matching the scene graph of the user experience space with the scene graph of the space assumed by the virtual content.

### CITATION LIST

### Non-Patent Document

Non-Patent Document 1: Tahara et al., Retargetable AR: Context-aware Augmented Reality in Indoor Scenes based on 3D Scene Graph, 2020 IEEE International Symposium on Mixed and Augmented Reality Adjunct (ISMAR-Adjunct)

### Patent Document

Patent Document 1: Japanese Unexamined Patent Application Publication No. 2020-503611

### SUMMARY OF THE INVENTION

### Problems to be Solved by the Invention

When the mapping of the virtual content is performed only when the scene graph of the user experience space completely includes the scene graph of the space assumed by the virtual content, the spatial constraint that the virtual content can be experienced becomes large.

Furthermore, in order to obtain a space in which virtual content can be experienced, the user needs to understand the context of the assumed space in advance and construct the space in which the user is located.

The present technology has been made in view of such a situation, and enables virtual content to be arranged in more various environments.

### Solutions to Problems

A display control device according to one aspect of the present technology includes: a real space graph acquisition unit that acquires a real space graph that is data of a graph structure including a plurality of real space nodes representing each of a plurality of real objects existing in a real space and a real space edge representing an arrangement relationship of the real objects in the real space; a template graph acquisition unit that acquires a template graph that is data of a graph structure including a plurality of template nodes representing each of a plurality of template objects that are virtual objects and a template edge representing an arrangement relationship of the template objects; a determination unit that determines a suitability between a first combination of the plurality of real space nodes and the real space edge and a second combination of the plurality of template nodes and the template edge; and an output control unit that controls output of an output device to perform arrangement control of arranging a virtual object on the real space when the suitability is a first suitability, and to perform display control related to arrangement of the virtual object different from output by the arrangement control when the suitability is a second suitability lower than the first suitability.

In one aspect of the present technology, a real space graph that is data of a graph structure including a plurality of real space nodes representing each of a plurality of real objects existing in a real space and a real space edge representing an arrangement relationship of the real objects in the real space is acquired, and a template graph that is data of a graph structure including a plurality of template nodes representing each of a plurality of template objects that are virtual objects and a template edge representing an arrangement relationship of the template objects is acquired. Further, a suitability between a first combination of the plurality of real space nodes and the real space edge and a second combination of the plurality of template node and the template edge is determined, and when the suitability is a first suitability, an output of an output device is controlled so as to perform arrangement control of arranging a virtual object on the real space, and when the suitability is a second suitability lower than the first suitability, the output of the output device is controlled so as to perform display control related to arrangement of the virtual object different from output by the arrangement control.

### BRIEF DESCRIPTION OF DRAWINGS

FIG. 1 is a diagram illustrating a configuration example of an information processing system according to an embodiment of the present technology.

FIG. 2 is a diagram illustrating another example of a display device of virtual content.

FIG. 3 is a diagram illustrating a display example of a virtual character.

FIG. 4 is a diagram illustrating an example of a virtual space.

FIG. 5 is a flowchart for explaining a reproduction process of virtual content.

FIG. 6 is a diagram illustrating an example of data constituting a virtual content data group.

FIG. 7 is a diagram illustrating an example of a scene graph of a user experience space.

FIG. 8 is a diagram illustrating an example of a space assumed by virtual content.

FIG. 9 is a diagram illustrating an example of mapping.

FIG. 10 is a flowchart for explaining context suitability evaluation processing in step S4 in FIG. 5.

FIG. 11 is a diagram illustrating an example of table information indicating a relationship between nodes.

FIG. 12 is a diagram illustrating an example of a scene graph of virtual content.

FIG. 13 is a diagram illustrating an example of a space to be subjected to context suitability evaluation.

FIG. 14 is a diagram illustrating another example of a space to be subjected to context suitability evaluation.

FIG. 15 is a diagram illustrating another example of a space to be subjected to context suitability evaluation.

FIG. 16 is a diagram illustrating an example of evaluation based on a node of a television.

FIG. 17 is a diagram illustrating an example of evaluation based on a node of a chair.

FIG. 18 is a diagram illustrating an example of evaluation based on an edge to which a label “front” is set.

FIG. 19 is a diagram illustrating an example of evaluation based on an attribute of “sittable”.

FIG. 20 is a diagram illustrating an example of an evaluation value of a node candidate set of each scene.

FIG. 21 is a diagram illustrating an example of mapping possibility determination.

FIG. 22 is a diagram illustrating a presentation example of an improvement method.

FIG. 23 is a diagram illustrating another presentation example of the improvement method.

FIG. 24 is a block diagram illustrating a configuration example of an HMD.

FIG. 25 is a block diagram illustrating a configuration example of an information processing apparatus.

FIG. 26 is a block diagram illustrating a functional configuration example of the information processing apparatus.

FIG. 27 is a block diagram illustrating another configuration example of the HMD.

### MODE FOR CARRYING OUT THE INVENTION

Hereinafter, embodiments for carrying out the present technology will be described. The description will be given in the following order.
1. Configuration of Information Processing System
2. Display of Object
3. Overview of Present Technology
4. Reproduction Process of Virtual Content
5. Three-Dimensional Map Acquisition in User Experience Space and Abstract Expression by Scene Graph
6. Context Suitability Evaluation of User Experience Space
7. Example of Mapping Possibility Determination
8. Presentation of Method for Improving Context
9. Configuration of Each Device
10. Modifications

### <<Configuration of Information Processing System>>

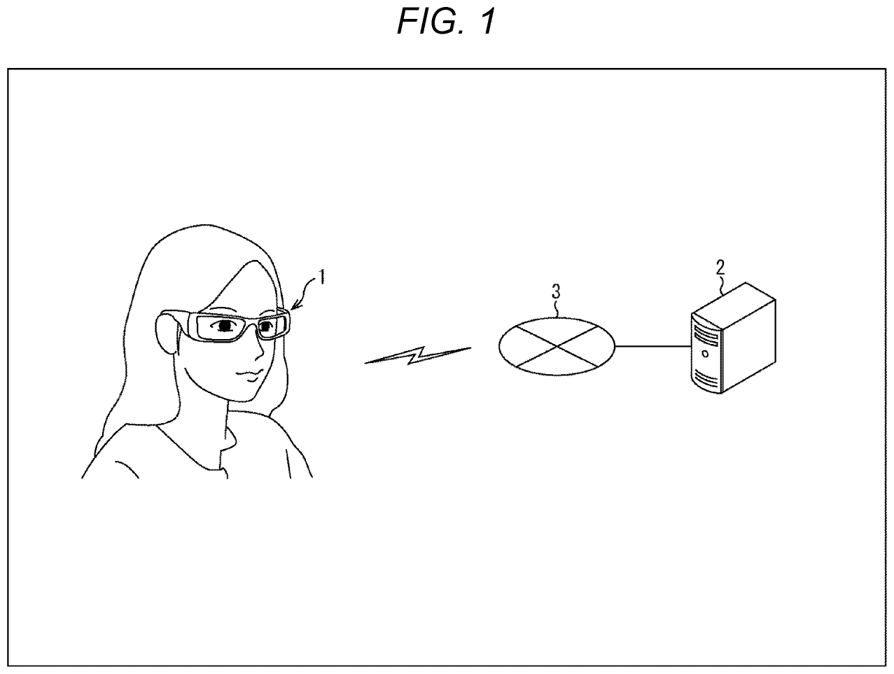

FIG. 1 is a diagram illustrating a configuration example of an information processing system according to an embodiment of the present technology.

The information processing system in FIG. 1 is configured by connecting a head mounted display (HMD) 1 and an information processing apparatus 2 via a network 3 such as a local area network (LAN) or the Internet. The HMD 1 and the information processing apparatus 2 may be connected by wire.

As illustrated in FIG. 1, the HMD 1 is a glasses-type wearable terminal including an optical see-through type display unit. The HMD 1 displays images of various objects such as characters on the display unit according to control by the information processing apparatus 2 performed via the network 3. A user will see an object superimposed on a scenery in front of the self.

The projection method of an image of an object may be a virtual image projection method or a retinal projection method of directly forming an image on the retina of the user's eye.

The information processing apparatus 2 reproduces the virtual content and transmits the image data obtained by the reproduction to the HMD 1 to display the image of the object on the HMD 1. The information processing apparatus 2 functions as a display control device that controls display of an image in the HMD 1. The information processing apparatus 2 includes, for example, a PC.

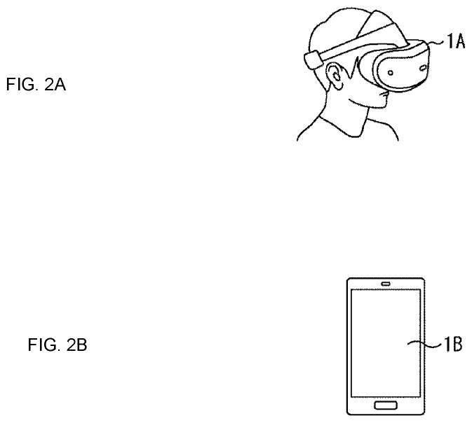

Instead of the HMD 1, a mobile terminal such as an HMD 1A which is a video see-through type HMD illustrated in A of FIG. 2 or a smartphone 1B illustrated in B of FIG. 2 may be used as the display device of the virtual content.

When the HMD 1A is used as the display device, the image of the virtual content reproduced by the information processing apparatus 2 is displayed in superposition with the video see-through image showing the scenery in front of the HMD 1A, which is captured by the camera provided in the HMD 1A. In front of the eyes of the user wearing the HMD 1A, a display that displays the image of the virtual content superimposed on the image captured by the camera is provided.

Furthermore, when the smartphone 1B is used, the image of the virtual content reproduced by the information processing apparatus 2 is displayed in superposition with the video see-through image showing the scenery in front of the smartphone 1B, which is captured by the camera provided on the back surface of the smartphone 1B. A display is provided in front of the smartphone 1B.

A projector that projects an image on a surface of an object existing in a real space may be used as a display device of virtual content. Various devices such as a tablet terminal and a television receiver can be used as display devices of virtual content.

In this manner, the user experiences the virtual content reproduced by the information processing apparatus 2 as augmented reality (AR) content or virtual reality (VR) content. When the HMD 1 of FIG. 1 is used as the display device, AR content is used as the virtual content. When the HMD 1A or the smartphone 1B of FIG. 2 is used, VR content is used as the virtual content.

The information processing apparatus 2 may reproduce mixed reality (MR) content in which AR content and VR content are combined.

### <<Display of Object>>

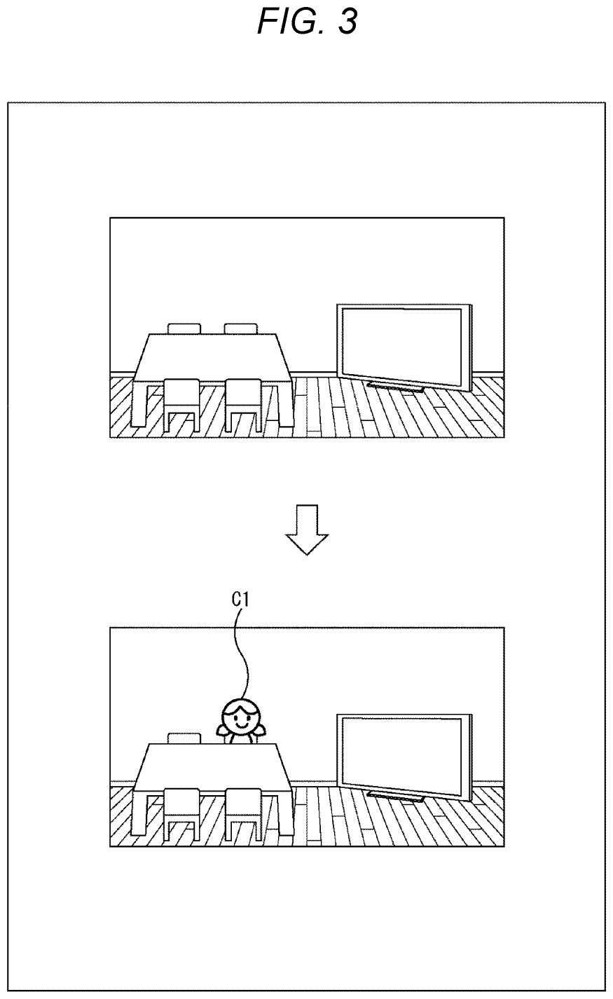

FIG. 3 is a diagram illustrating a display example of objects included in virtual content.

It is assumed that a user who experiences virtual content is in a living room as illustrated in the upper part of FIG. 3 in a state of wearing the HMD 1. The living room illustrated in the upper part of FIG. 3 is a real space in which the user experiences virtual content. Hereinafter, the real space is appropriately referred to as a user experience space.

In the example in the upper part of FIG. 3, a television, a table, and a chair are illustrated as objects existing in the user experience space. Four chairs are arranged around the table, and a television is arranged near the table.

When the virtual content is reproduced and the image data of the virtual content is transmitted in the information processing apparatus 2, the image of the object is displayed to be superimposed on the user experience space as illustrated in the lower part of FIG. 3.

In the example in the lower part of FIG. 3, an image of a virtual character Cl, which is a virtual object, sitting on a chair is displayed. As the image of the virtual character Cl, for example, a moving image of the virtual character Cl sitting on a chair is displayed. The user sees the virtual character Cl actually sitting on a chair in front of the user.

The virtual character Cl has, for example, a three-dimensional shape. The appearance of the virtual character Cl is different according to the position, posture, and the like of the user in the user experience space. For example, an image of the virtual character Cl expressing appearance of different sizes and different angles is displayed according to the position, posture, and the like of the user.

Hereinafter, a case where the virtual object included in the virtual content is a human character will be mainly described, but another object such as an animal, a vehicle, furniture, or a building can be used as the virtual object.

Such display of the image is realized by arranging (mapping) the virtual object included in the virtual content according to the context of the user experience space.

The user experience space is a space unknown to the information processing apparatus 2 until the three-dimensional shape is measured. Display of an image as illustrated in FIG. 3 is realized by applying virtual content created assuming a specific space to an unknown space.

The virtual content is created assuming a space in which a virtual object is displayed. An assumed space is prepared for each virtual content. Hereinafter, a space assumed by the virtual content is appropriately referred to as a virtual space.

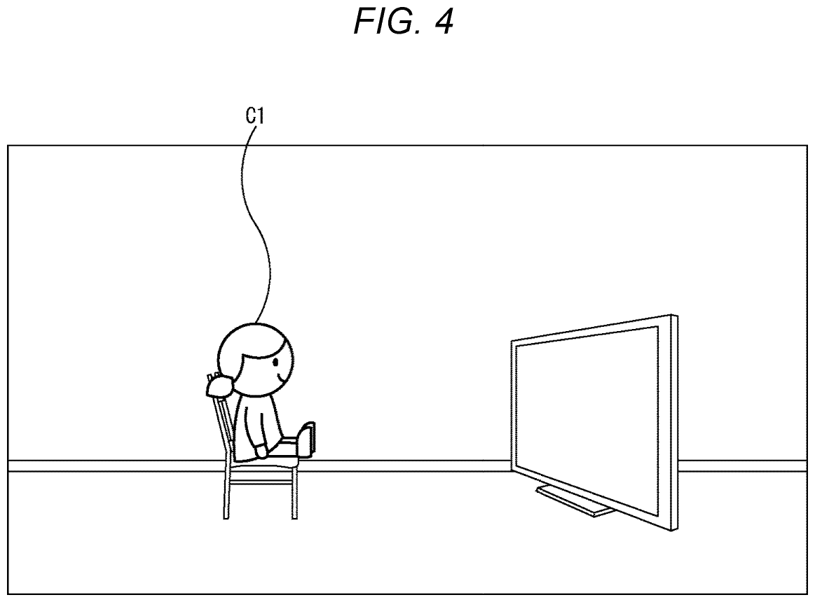

FIG. 4 is a diagram illustrating an example of a virtual space.

As illustrated in FIG. 4, a virtual space in which virtual objects are arranged is assumed for each virtual content. In the example of FIG. 4, a television and one chair are arranged in a virtual space. The television is arranged in front of the chair.

Assuming such a virtual space, for example, as illustrated in FIG. 4, virtual content including a three-dimensional model of a virtual character Cl sitting on a chair in front of a television is created.

When the context of the virtual space and the context of the user experience space satisfy a predetermined condition, such that the same object as the object arranged in the virtual space also exists in the user experience space, mapping of the virtual character Cl is performed. Each piece of virtual content is content for the user experience space having the same or similar context as the virtual space assumed by each piece of virtual content.

Mapping is performed according to the position and posture of the user in the user experience space, the positional relationship of the object in the user experience space, and the like, whereby the appearance of the virtual character Cl as described with reference to FIG. 3 is realized.

### <<Overview of Present Technology>>

The present technology relaxes a constraint of a space to which a virtual object can be mapped according to an intention of a creator by using a suitability of context between a scene graph of a user experience space and a scene graph of a virtual space. Relaxation of space constraints enables mapping of virtual objects to more diverse spaces.

That is, the mapping of the virtual object is allowed not only when the context of the user experience space completely includes the context of the virtual space, but also when the context of the user experience space partially includes the context of the virtual space, for example. As described in detail below, a scene graph is data of a graph structure that represents the context of a space using nodes and edges. A node represents an object or the like in space, and an edge represents a relationship between objects.

Furthermore, the present technology presents information for enhancing the suitability of the context of the user experience space with respect to the context of the virtual space, thereby assisting the user in constructing a space suitable for the context of the virtual space.

Specifically, the following processing is performed.
Semantic information and geometric information of the three-dimensional space are represented in an abstract manner as a three-dimensional scene graph, and the suitability of the context is quantitatively evaluated on the basis of the scene graph of the user experience space and the scene graph of the virtual space. Mapping of the object is performed when the suitability of the context satisfies the allowable suitability.
In the evaluation of the suitability of the context, the evaluation of the node suitability, the evaluation of the edge suitability, and the evaluation of the suitability of various attributes possessed by the node are performed on the basis of the scene graphs of both spaces.
When the suitability of the context of the user experience space to the context of the virtual space does not satisfy the allowable suitability, assistance is provided to the user to efficiently increase the suitability.

### <<Reproduction Process of Virtual Content>>

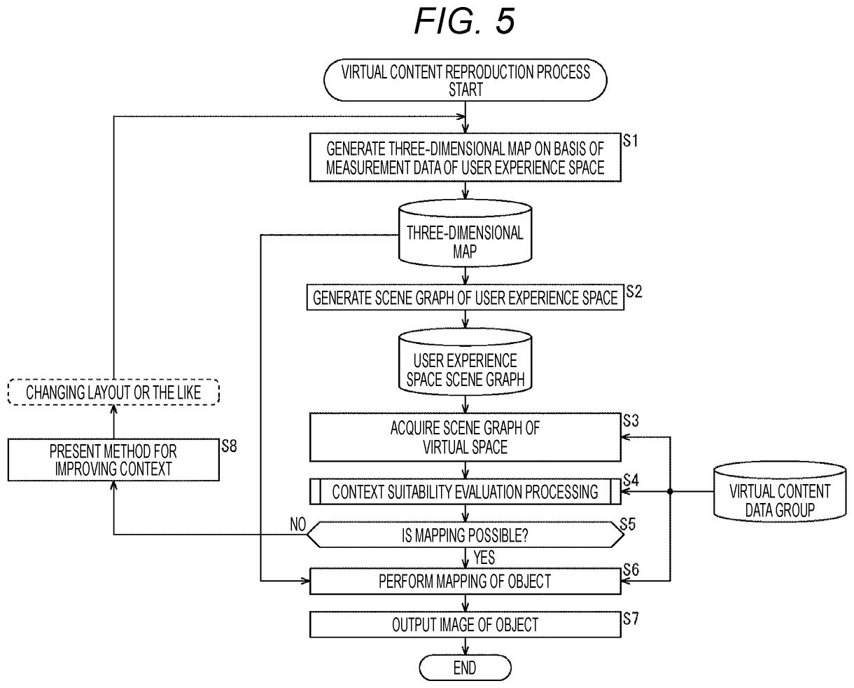

A reproduction process of virtual content will be described with reference to the flowchart of FIG. 5. Details of the processing of each step will be appropriately described later.

In step S1, the information processing apparatus 2 generates a three-dimensional map on the basis of the measurement data of the user experience space.

In step S2, the information processing apparatus 2 generates a scene graph of the user experience space on the basis of the three-dimensional map.

In step S3, the information processing apparatus 2 acquires a scene graph of the virtual space. The scene graph of the virtual space is prepared in advance as data of a template constituting a virtual content data group for each virtual content.

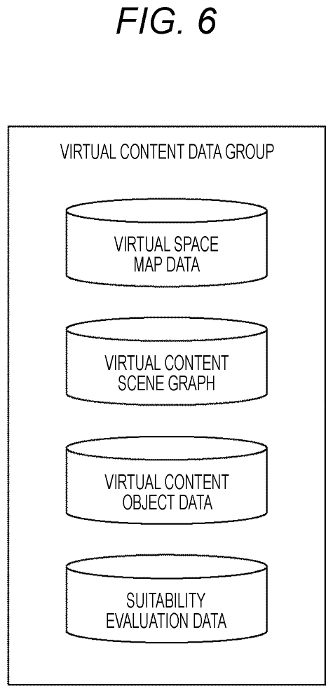

FIG. 6 is a diagram illustrating an example of data constituting a virtual content data group.

As illustrated in FIG. 6, the virtual content data group includes virtual space map data, a virtual content scene graph, virtual content object data, and suitability evaluation data.

The virtual space map data is data of a three-dimensional map of the virtual space. The shape and size of the virtual space, the shape and size of the object arranged in the virtual space, and the like are represented by the virtual space map data.

The virtual content scene graph is a scene graph representing the context of the virtual space.

The virtual content object data is data of a virtual object. For example, data of a three-dimensional model of a virtual character is prepared as virtual content object data. The image of the virtual object is displayed by mapping the virtual object according to the position, posture, and the like of the user in the user experience space.

The suitability evaluation data is data used for context suitability evaluation that is evaluation of suitability between the context of the user experience space and the context of the virtual space. Information indicating a relationship between nodes and the like are prepared as suitability evaluation data.

The virtual content data group including the above data may be prepared in the information processing apparatus 2, or may be prepared in an external device such as a server on the Internet. All the data constituting the virtual content data group may not be prepared in the same device but may be prepared in a distributed manner in a plurality of devices.

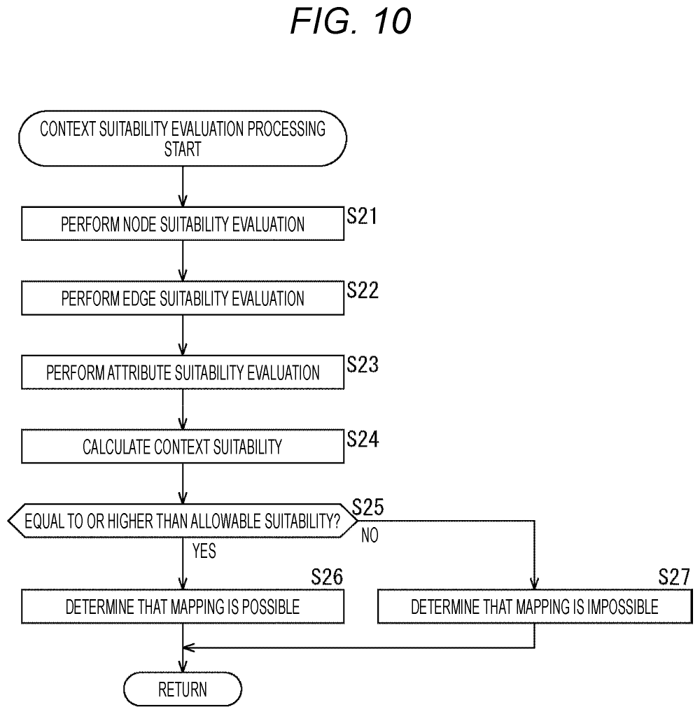

Returning to the description of FIG. 5, in step S4, the information processing apparatus 2 performs context suitability evaluation processing. In the context suitability evaluation processing, data constituting the virtual content data group is appropriately referred to. Details of the context suitability evaluation processing will be described later with reference to the flowchart of FIG. 10.

In step S5, the information processing apparatus 2 determines whether or not mapping of a virtual object is possible.

When it is determined in step S5 that mapping is possible, the information processing apparatus 2 performs mapping of the virtual object in step S6. For mapping of the virtual object, a three-dimensional map of the user experience space, virtual space map data constituting a virtual content data group, virtual content object data, and the like are used.

In step S7, the information processing apparatus 2 outputs the image of the virtual object from the HMD 1. When the output of the image of the virtual object ends, the processing ends.

On the other hand, when it is determined in step S5 that the mapping of the virtual object is not possible, in step S8, the information processing apparatus 2 presents a method for improving the context of the user experience space.

The user who receives the presentation of the improvement method performs context improvement such as changing a layout of furniture in the user experience space or bringing furniture in another space (room) to add to the user experience space according to the presentation content. Thereafter, the processing returns to step S1, and the above processing is repeated.

The following processing will be sequentially described.
Three-Dimensional Map Acquisition in User Experience Space and Abstract Expression by Scene Graph (steps S1 and S2 in FIG. 5)
Context Suitability Evaluation of User Experience Space (step S4 in FIG. 5)
Presentation of Method for Improving Context (step S8 in FIG. 5)

### Three-Dimensional Map Acquisition in User Experience Space and Abstract Expression by Scene Graph>>

### <Acquisition of Three-Dimensional Map of User Experience Space>

In order to experience the virtual content, the user measures his/her own room serving as a user experience space with various sensors or the like. An object such as furniture is arranged in the user's room.

An indoor space other than the user's room may be used as the user experience space. Instead of an indoor space, an outdoor space in which an object is arranged may be used as the user experience space.

As the measurement data, an RGB image acquired by an RGB camera, a distance image acquired by a depth sensor, point cloud data acquired by a distance measuring sensor such as LiDAR, or the like is used. The user experience space is measured using, for example, a smartphone of the user equipped with various sensors such as an RGB camera, a depth sensor, and a distance measurement sensor. CAD data representing the three-dimensional shape of the user experience space may be used as the measurement data.

A three-dimensional map of the user experience space is generated on the basis of the measurement data indicating the measurement result by the user (step S1 in FIG. 5).

The three-dimensional map is data having geometric information such as a three-dimensional shape, a position, and a posture of an object present in the user experience space and the user experience space, and semantic information such as attributes possessed by each object. The attribute of the object includes a category, an ID, a material, a color, an affordance, and the like of the object. An attribute of an object is defined by an identification label set for each object.

The generation of the three-dimensional map can be performed using a computer vision technology described in the following document.
Document 1 “G. Narita et al. Panopticfusion: Online volumetric semantic mapping at the level of stuff and things. In IEEE/RSJ Int. Conf. on Intelligent Robots and Systems (IROS), 2019.”
Document 2 “J. Hou et al. 3D-SIS: 3D Semantic Instance Segmentation of RGB-D Scans. CVPR, 2019.”

### <Abstract Representation by Scene Graph>

A scene graph representing a context of a three-dimensional space is data having a graph structure in which an object or a user existing in the space or a virtual object displayed superimposed on a scenery in the space is represented as a node, and a relationship between nodes is represented using an edge.

The relationship between the nodes is expressed using description in a natural language. For example, when there are a chair and a table in the user experience space, and the chair and the table are arranged close to each other, the chair node and the table node are connected by an edge having a label “near”.

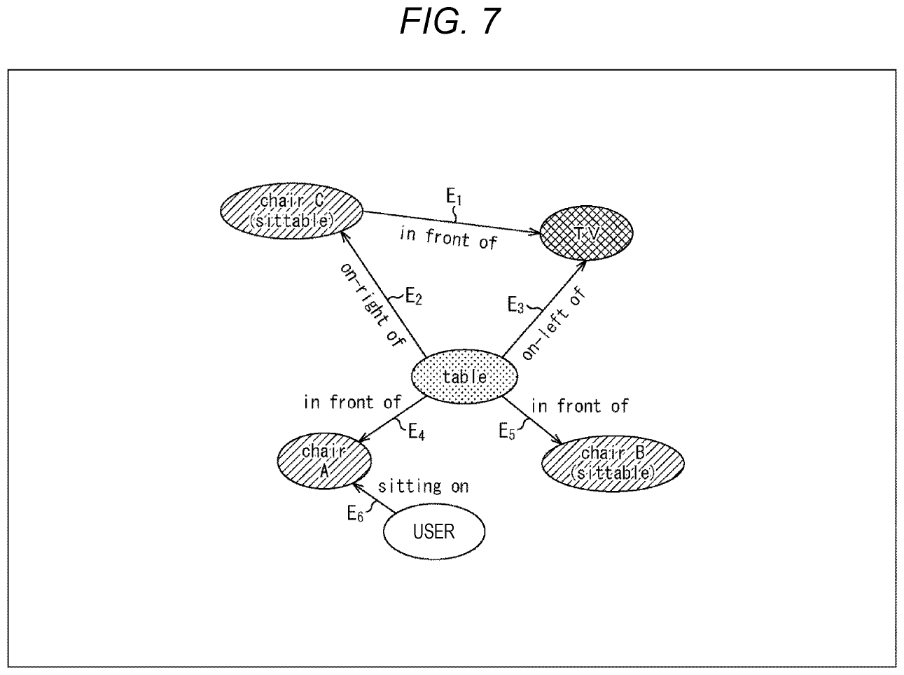

FIG. 7 is a diagram illustrating an example of a scene graph of a user experience space.

When a table, a television, and chairs A to C exist in the user experience space and are arranged so as to have a predetermined positional relationship, as illustrated in FIG. 7, a scene graph of the user experience space is configured by using six nodes representing those objects and users.

In the example of FIG. 7, the node of the chair C and the node of the television are connected by an edge E₁ having a label “in front of”. The label of the edge E₁ indicates that the chair C is in front of the television.

In addition, the node of the chair C and the node of the table are connected by an edge E₂ having a label “on-right of”. The label of the edge E₂ represents that the table is on the right side of the chair C.

The node of the television and the node of the table are connected by an edge E₃ having a label of “on-left of”. The label of edge E₃ indicates that the table is on the left side of the television.

The node of the table and the node of the chair A and the edge connecting the node of the table and the node of the chair B are also connected by edges E₄ and E₅ in which labels indicating positional relationships therebetween are set.

In the example of FIG. 7, the user is sitting on the chair A, which is represented by the label of the edge E₆ connecting the node of the chair A and the node of the user. A label “sitting on” indicating that the user is sitting on the chair A is set to the edge E₆.

As described above, as the label set to the edge, a label indicating a spatial positional relationship (front/behind/left/right/on/above/under/near, . . . ), a label indicating an action performed by the user using an object, or the like is used.

A label indicating the content of the interaction of the virtual content (the content of the action of the virtual object) may be used. For example, in the interaction such as the virtual character “sitting” on a chair, the three-dimensional shape, position, and posture of each object in the user experience space are specified from the three-dimensional map, and estimated on the basis of the mutual distance, orientation, and the like.

By using the abstract representation by the three-dimensional map and the scene graph as described above, it is possible to map the virtual object included in the virtual content created assuming a predetermined space to the user experience space which is another space having a similar context to the context of the virtual space.

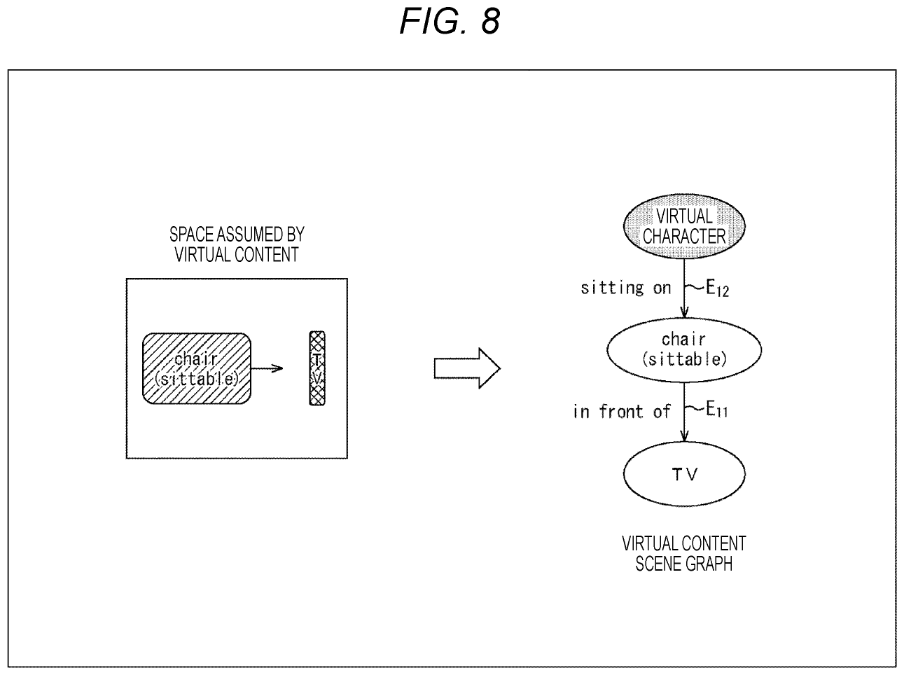

For example, the virtual content in the scenario of “A virtual character sits on a chair that is in front of a television and on which the virtual character can sit.” is created assuming a space as illustrated on the left side of FIG. 8. The space illustrated on the left side of FIG. 8 is a virtual space in which a chair is arranged in front of the television. A label representing an affordance of “sittable” is set on the chair.

As illustrated on the right side of FIG. 8, the scene graph of the virtual space is obtained by connecting the chair node and the television node with an edge E₁₁ having a label of “in front of”. The node of the virtual character is connected to the node of the chair by an edge E₁₂ having a label “sitting on”.

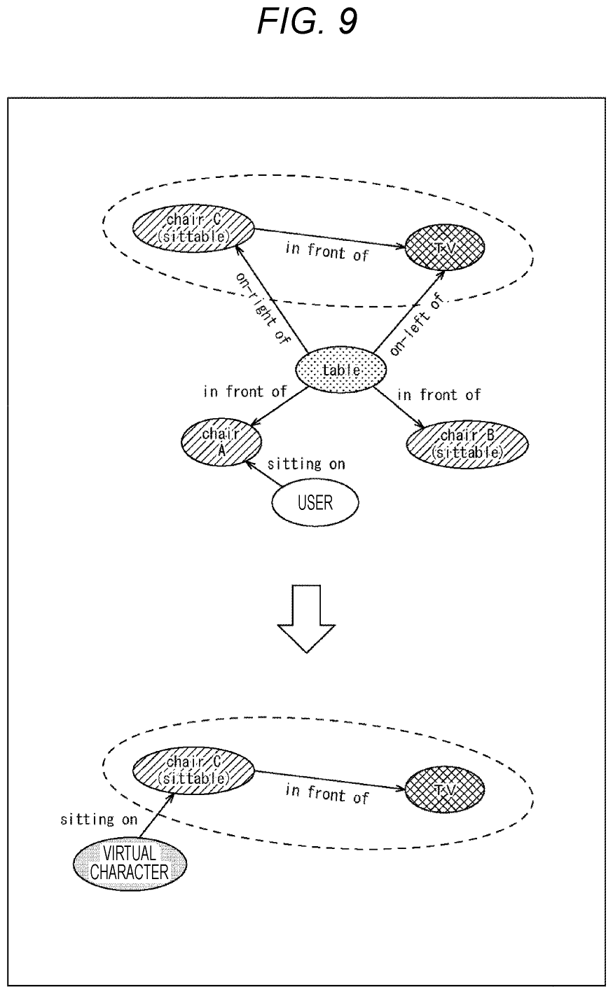

As illustrated in FIG. 9, the mapping of the virtual object included in the virtual content created assuming such a virtual space is performed such that a portion in which the node of the television and the node of the chair are connected by the edge of “front” is searched from the scene graph of the user experience space, and the virtual object is mapped to the object in the corresponding real space.

In the example of FIG. 9, a portion surrounded by a broken line having the same graph structure as the scene graph of the virtual space described with reference to FIG. 8 is searched from the entire scene graph of the user experience space described with reference to FIG. 7, and mapping is performed such that the virtual character sits on a chair C that is an object in the corresponding real space.

In this manner, processing of searching for a portion having a graph structure same as or similar to the scene graph of the virtual space assumed by the virtual content from the entire scene graph of the user experience space is performed as the context suitability evaluation.

Here, since the user experience space is a real space, the scene graph of the user experience space is a real space graph representing a context of the real space. The real space graph is data of a graph structure including a real space node that is a node representing a real object existing in the real space and a real space edge that is an edge representing an arrangement relationship or the like of the real object in the real space.

On the other hand, the virtual space is a space prepared on the assumption for each virtual content. A virtual space is prepared as a template for each virtual content. The scene graph of the virtual space is a template graph prepared as a template representing the context of the virtual space. The template graph is data of a graph structure including a template node that is a node representing a virtual object such as furniture arranged in the virtual space and a template edge that is an edge representing an arrangement relationship or the like of the virtual object in the virtual space.

### <<Context Suitability Evaluation of User Experience Space>>

When the mapping of the virtual object is performed only when the scene graph of the virtual space assumed by the virtual content is completely included in the scene graph of the user experience space, the mappable space is greatly limited.

The context suitability evaluation of the user experience space is to enable flexible mapping of virtual objects.

### <Overall Flow of Context Suitability Evaluation>

The context suitability evaluation processing performed in step S4 of FIG. 5 will be described with reference to the flowchart of FIG. 10.

The processing illustrated in FIG. 10 is performed after the scene graph of the virtual space is acquired in step S3 of FIG. 5.

In step S21, the information processing apparatus 2 performs node suitability evaluation.

In step 522, the information processing apparatus 2 performs edge suitability evaluation.

In step 523, the information processing apparatus 2 performs attribute suitability evaluation.

In step S24, the information processing apparatus 2 calculates the context suitability.

In step S25, the information processing apparatus 2 determines whether or not the context suitability is equal to or higher than the allowable suitability. The allowable suitability is set as a threshold.

When it is determined in step S25 that the context suitability is equal to or higher than the allowable suitability, the information processing apparatus 2 determines in step S26 that mapping is possible.

On the other hand, when it is determined in step S25 that the context suitability is less than the allowable suitability, the information processing apparatus 2 determines in step S27 that mapping is impossible.

After the determination is made in step S26 or step S27, the process returns to step S4 in FIG. 5, and the subsequent processes are performed.

In this manner, the context suitability evaluation of the user experience space is performed in stages by using three types of evaluation of the node suitability evaluation, the edge suitability evaluation, and the attribute suitability evaluation.

Hereinafter, details of each evaluation will be described in order. A scenario of the virtual content will be described as “A virtual character sits on a chair that is in front of a television and on which the virtual character can sit.” (scenario A).

### <Node Suitability Evaluation>

The scene graph of the scenario A is the scene graph (graph A) described with reference to FIG. 8. On the other hand, the scene graph of the user experience space is the scene graph (graph B) described with reference to FIG. 7.

The information processing apparatus 2 evaluates the suitability of the node of the graph B for each node included in the graph A except for the node of the virtual character, and calculates a node matching evaluation value Cₙ.

The node matching evaluation value Cₙ is determined by repeating point addition processing according to the following norms (1) to (3) with Cₙ=0 as an initial value. The evaluation values a, b, and c are values having a relationship of a≥b≥c≥0.

### Norm (1)

When a node of the same category as the node of the graph A exists in the graph B

Cₙ=Cₙ+a

### Norm (2)

When the category is different from that of the node of the graph A, but a node of a category belonging to the same superordinate concept exists in the graph B

Cₙ=Cₙ+b

### Norm (3)

When the category is different from that of the node of the graph A, but there is a node having the same attribute in the graph B

Cₙ=Cₙ+c

The superordinate concept of the norm (2) is defined in advance on the basis of a concept dictionary of a natural language or the like. A database representing a concept relationship between categories of nodes defined in advance is prepared in the information processing apparatus 2.

For example, the following Document 3 describes that there is a “seat” as a superordinate concept of a “chair”, and there are sofa, stool, bench, and the like as categories having the same superordinate concept as the “chair”.
Document 3 “WordNet, https://wordnet.princeton.edu/”

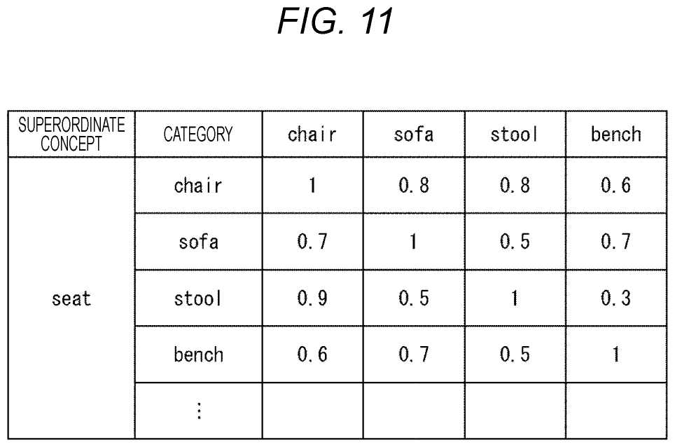

FIG. 11 is a diagram illustrating an example of table information indicating a relationship between nodes.

In the example of FIG. 11, “chair”, “sofa”, “stool”, “bench”, . . . are illustrated as categories of objects whose superordinate concept is the concept of “seat”.

When attention is paid to the second line of FIG. 11, there is a node of “chair” as a node of the graph A, and when a node of “sofa” belonging to the same superordinate concept of “seat” exists in the graph B, the evaluation value b to be added according to the norm (2) is “0.8”. In addition, the evaluation value b to which points are added according to the norm (2) when the node of “stool” exists in the graph B is “0.8”, and the evaluation value b to which points are added according to the norm (2) when the node of “bench” exists in the graph B is “0.6”.

Note that the evaluation value a to which points are added according to the norm (1) when a node of the same category as the node of the graph A exists in the graph B is “1”.

Table information in which such an evaluation value is set is prepared as suitability evaluation data (FIG. 6). By using the suitability evaluation data, it is possible to evaluate the closeness of the node of the context of the user experience space to the context of the virtual space.

As a situation to which points are added according to the norm (3), there is a situation in which, when a chair node having an attribute of “sittable” that the user can sit exists in the scene graph of the virtual space, a node in a different category that the user can sit, such as a bed or cushion node, exists in the scene graph of the user experience space instead of the chair node.

According to the above norm, for example, a combination of nodes satisfying the node matching evaluation value Cₙ>0 is extracted from the graph B as a node candidate set. The node candidate set is a set of nodes corresponding to objects that may be used for mapping.

Edge suitability evaluation and attribute suitability evaluation are performed on the node candidate set extracted on the basis of the node matching evaluation value Cₙ. The edge suitability evaluation and the attribute suitability evaluation are performed on the node candidate set including the same or similar nodes as the nodes existing in the scene graph of the virtual space.

### <Edge Suitability Evaluation>

The information processing apparatus 2 evaluates a suitability of an edge between nodes included in the node candidate set extracted from the graph B with respect to an edge indicating a relationship between nodes included in the graph A, and calculates an edge matching evaluation value Cₑ. Evaluation of the suitability of the edges between the nodes included in the node candidate set is performed by the same number as the number of edges representing the relationship between the nodes included in the graph A.

The edge matching evaluation value Cₑ is determined by repeating the addition processing according to the following norm until the evaluation for all the edges of the node candidate set is completed with Cₑ=0 as an initial value. The evaluation value d is a value of d>0.

### Norm

When there is an edge representing the same relationship as the edge included in the graph A at an edge between nodes constituting the node candidate set

Cₑ=Cₑ+d

A database defining an evaluation value according to the degree of similarity of edges may be prepared in advance in the information processing apparatus 2. In this case, the degree of similarity is specified on the basis of the type of label set to the edge, and the evaluation value is weighted according to the specified degree of similarity.

When quantitative information indicating a positional relationship such as an absolute distance and a relative arrangement angle between objects corresponding to nodes is set in an edge by using a label, the evaluation value may be weighted according to the quantitative information. Quantitative information indicating a positional relationship between objects is estimated on the basis of, for example, a three-dimensional map.

In this manner, not only the positional relationship and the posture relationship but also quantitative information such as a distance and an angle may be represented by an edge. It is possible that a relationship between objects of at least one of a position, a posture, a distance, or an angle is represented by an edge.

### <Attribute Suitability Evaluation>

The information processing apparatus 2 evaluates the suitability of the attribute set for the node included in the node candidate set extracted from the graph B with respect to the attribute set for the node included in the graph A, and calculates the attribute matching evaluation value Cₐ. The suitability of the attributes set for the nodes included in the node candidate set is evaluated by the same number as the number of attributes set for the nodes included in the graph A.

The attribute matching evaluation value Cₐ is determined by repeating the addition processing according to the following norm until the evaluation for all the attributes is completed with Cₐ=0 as an initial value. The evaluation value e is a value of e>0.

### Norm

When there is a node in which the same attribute as the attribute set for the node included in the graph A is set in the nodes constituting the node candidate set

Cₐ=Cₐ+e

As in the case of the edge suitability evaluation, a database defining an evaluation value according to the degree of similarity of attributes may be prepared in advance in the information processing apparatus 2. In this case, the evaluation value is weighted according to the degree of similarity of the attributes set in the node. For example, when a color attribute is set for a chair node, a score higher than that of a chair node for which an attribute of a different color is set is added to a chair node for which an attribute of a similar color is set.

### <Context Suitability Evaluation and Mapping Possibility Determination>

The context suitability is calculated on the basis of the node matching evaluation value Cₙ, the edge matching evaluation value Cₑ, and the attribute matching evaluation value Cₐ calculated as described above (step S24 in FIG. 10).

For example, the sum value is calculated by the weighted sum of the node matching evaluation value Cₙ, the edge matching evaluation value Cₑ, and the attribute matching evaluation value Cₐ. Furthermore, the ratio of the sum value calculated from the graph B by the weighted sum to the sum value of the evaluation values when the contexts completely match is calculated as the context suitability of the user experience space.

The weight to be used for calculating the weighted sum may be determined in advance on the basis of an element regarded as important by the creator of the virtual content. For example, when node similarity is regarded as important, a value larger than the weight of the edge matching evaluation value Cₑ and the weight of the attribute matching evaluation value Cₐ is set as the weight of the node matching evaluation value Cₙ. Different weights may be set as the weights of the node matching evaluation value Cₙ, the edge matching evaluation value Cₑ, and the attribute matching evaluation value Cₐ.

After the context suitability is calculated, mapping possibility determination is performed. The mapping possibility determination is performed by comparing the context suitability with the allowable suitability serving as a threshold. When a plurality of node candidate sets is extracted from the graph B and the respective context suitability is calculated, for example, comparison with the allowable suitability is performed using the maximum context suitability.

The allowable suitability (%) is set in advance by a creator of the virtual content or the like. When the allowable suitability is set to, for example, 80%, it is determined that mapping is possible when a context suitability of 80% or more is calculated. When the context suitability has a first suitability that is equal to or greater than the allowable suitability, it is determined that mapping is possible, and when the context suitability has a second suitability that is less than the allowable suitability, it is determined that mapping is not possible.

When it is determined that mapping is possible, the three-dimensional information of the real object corresponding to the node constituting the node candidate set is acquired from the three-dimensional map and used for mapping of the virtual object.

Note that a specific node or edge may be set in advance as an essential element. A node candidate set lacking nodes or edges set as essential elements may be automatically rejected from the evaluation target.

Since the context suitability evaluation is performed as described above, it is possible to flexibly map virtual objects to spaces of various contexts. The user can use more spaces as a user experience space.

### <<Example of Mapping Possibility Determination>>

Next, specific examples of context suitability evaluation and mapping possibility determination for various spaces will be described.

### <Specific Example of Scene Graph>

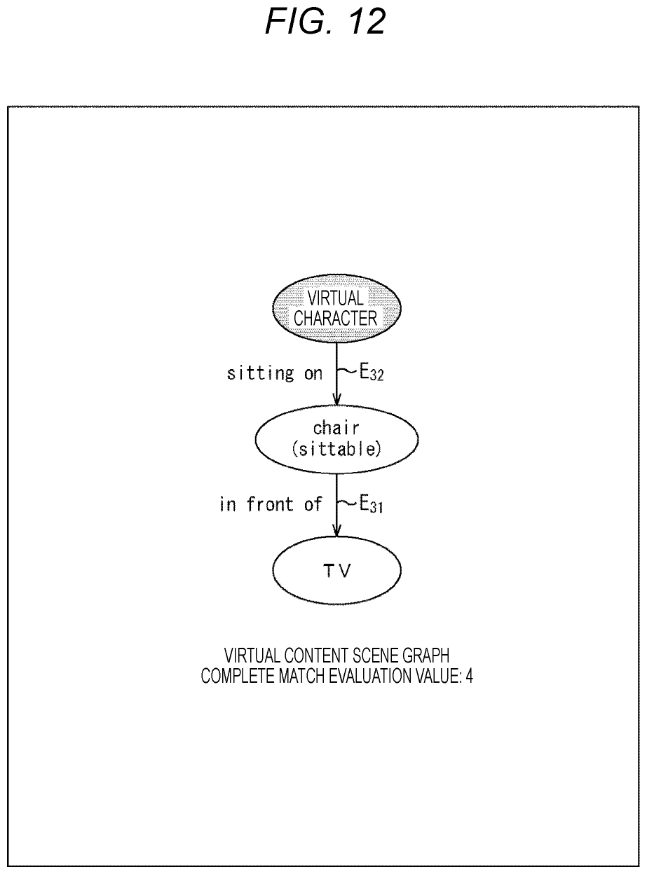

FIG. 12 is a diagram illustrating an example of a scene graph of a virtual space assumed by virtual content.

The scene graph illustrated in FIG. 12 is the same scene graph as the scene graph described with reference to FIG. 8. Processing when the scenario of the virtual content is a scenario of “A virtual character sits on a chair that is in front of a television and on which the virtual character can sit.” will be described.

Then, contexts of the user experience space that are required to be determined to be mappable are the following four contexts.
(1) Including a node of a chair
(2) Including a node of a television
(3) A chair node and a television node are connected by an edge representing a “front” relationship
(4) An attribute “sittable” is set in the node of the chair

The weights of the node matching evaluation value Cₙ, the edge matching evaluation value Cₑ, and the attribute matching evaluation value Cₐ when the evaluation value is obtained by the weighted sum are set to “1.0”. In this case, the sum value (evaluation value) of the node matching evaluation value Cₙ, the edge matching evaluation value Cₑ, and the attribute matching evaluation value Cₐ when a space having a context completely matching the context of the virtual space assumed by the virtual content is targeted is “4.0” when each evaluation value is obtained as described later.

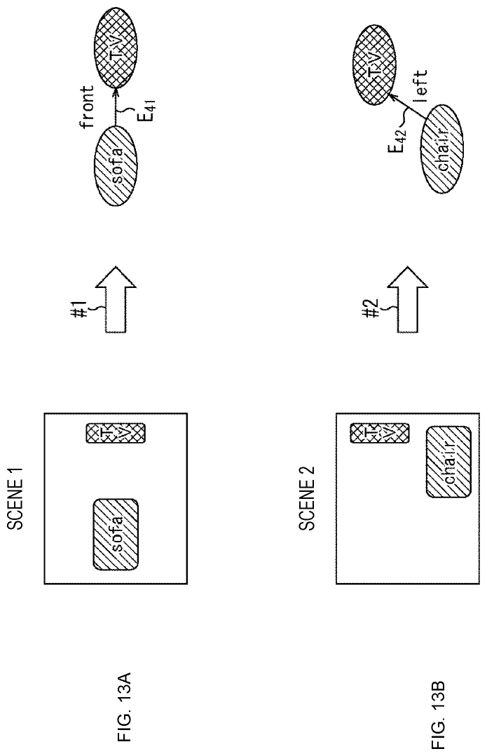

FIGS. 13 to 15 are diagrams illustrating examples of spaces to be subjected to the context suitability evaluation.

Scene 1 illustrated in A of FIG. 13 is a space where a sofa is arranged in front of a television. The scene graph of Scene 1 includes a node of a sofa and a node of a television as indicated by a portion pointed by arrow #1. The nodes of the sofa and the television are connected by an edge E₄₁ in which a label indicating that there is a television in front of the sofa is set.

Scene 2 illustrated in B of FIG. 13 is a space where a television is disposed on the left side of a chair. The scene graph of Scene 2 includes a node of a chair and a node of a television as indicated by a portion pointed by arrow #2. The nodes of the chair and the television are connected by an edge E₄₂ in which a label indicating that the television is on the left side of the chair is set.

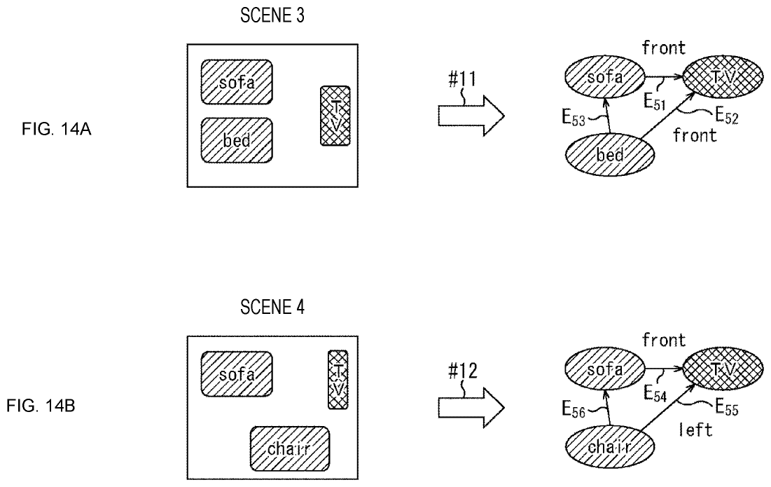

Scene 3 illustrated in A of FIG. 14 is a space where a sofa and a bed are arranged in front of a television. The scene graph of Scene 3 includes a sofa node, a bed node, and a television node as indicated by a portion pointed by arrow #11. The nodes of the sofa and the television are connected by an edge E₅₁ in which a label indicating that there is a television in front of the sofa is set. The nodes of the bed and the television are connected by an edge E₅₂ in which a label indicating that the television is in front of the bed is set. The nodes of the sofa and the bed are connected by an edge E₅₃.

Scene 4 illustrated in B of FIG. 14 is a space where a sofa is disposed in front of a television and the television is disposed on the left side of a chair. The scene graph of Scene 4 includes a sofa node, a chair node, and a television node as indicated by a portion pointed by arrow #12. The nodes of the sofa and the television are connected by an edge E₅₄ in which a label indicating that there is a television in front of the sofa is set. The nodes of the chair and the television are connected by an edge E₅₅ in which a label indicating that the television is on the left side of the chair is set. The nodes of the sofa and of the chair are connected by an edge E₅₆.

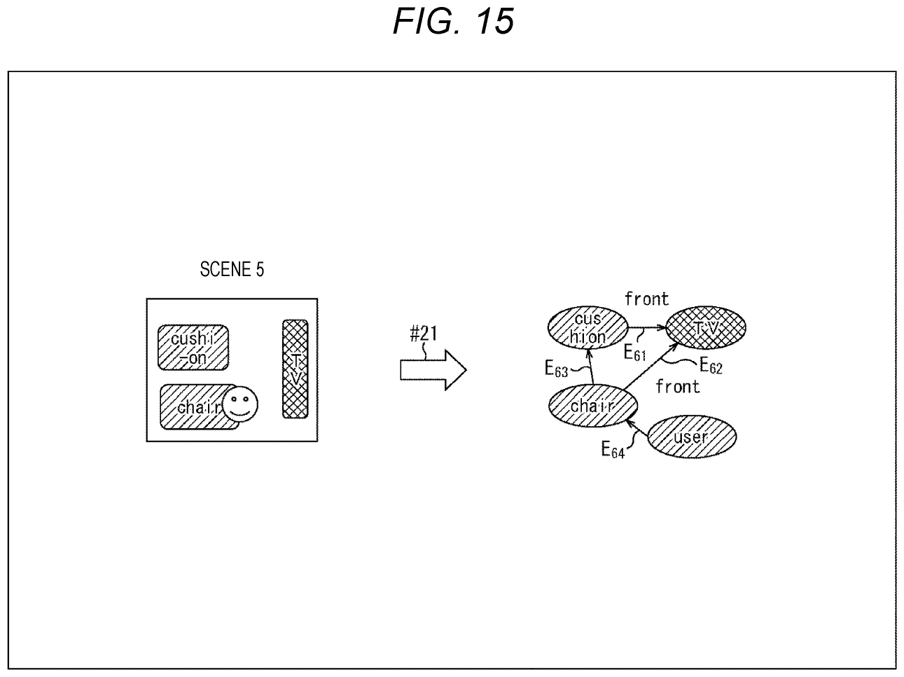

Scene 5 illustrated in FIG. 15 is a user experience space in which a cushion and a chair are arranged in front of a television. A user is sitting on a chair. The scene graph of Scene 5 includes a cushion node, a television node, a chair node, and a user node as indicated by a portion pointed by arrow #21. The nodes of the cushion and the television are connected by an edge E₆₁ in which a label indicating that the television is in front of the cushion is set. The nodes of the chair and the television are connected by an edge E₆₂ in which a label indicating that the television is in front of the chair is set. The nodes of the cushion and the chair are connected by an edge E₆₃. The nodes of the chair and the user are connected by an edge E₆₄ in which a label indicating that the user is sitting on the chair is set.

The context suitability evaluation and the mapping possibility determination when the space in which the context is expressed by such a scene graph is set as the user experience space will be described.

### <Example of Node Suitability Evaluation>

In the node suitability evaluation (step S21 in FIG. 10), whether the nodes of the television and the chair are included in the scene graph is evaluated for each scene.

Here, it is assumed that the sofa and the chair are objects in a category having the same superordinate concept. Points are also given to the sofa on the basis of the suitability evaluation data as described with reference to FIG. 11.

In addition, the cushion node and the bed node are nodes in which the same attribute of “sittable” is set although the categories are different. Points corresponding to the attributes are also given to the nodes of the cushion and the bed.

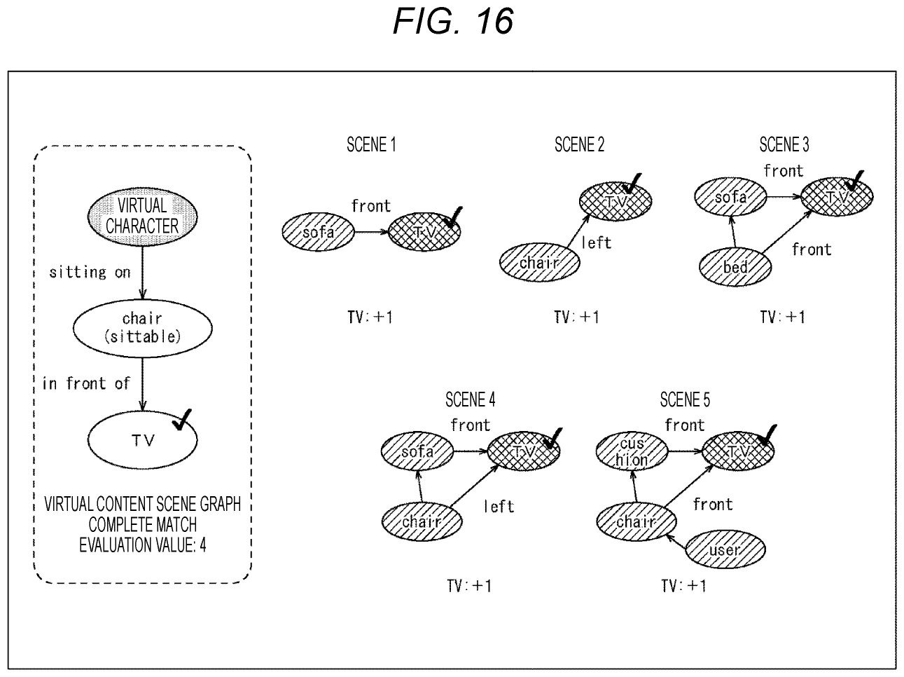

FIG. 16 is a diagram illustrating an example of evaluation as to whether a node of a television is included in a scene graph.

As indicated by a check mark, the scene graph of each of Scenes 1 to 5 includes a node of a television. In this case, in each scene graph, a portion including a television node and a node connected to the television node is extracted as a node candidate set.

For example, from the scene graph of Scene 1, a portion (entire scene graph) including a television node and a sofa node is extracted as a node candidate set. The node candidate set of Scene 1 is referred to as a television-sofa node candidate set. Similarly, other node candidate sets will be described using the names of the nodes constituting the node candidate set.

A television-chair node candidate set is extracted from Scene 2, and a television-sofa node candidate set and a television-bed node candidate set are extracted from Scene 3. From Scene 4, a television-sofa node candidate set and a television-chair node candidate set are extracted. From Scene 5, a television-cushion node candidate set and a television-chair node candidate set are extracted.

A value of “1.0” is added to the node matching evaluation value Cₙ of the node candidate set of each scene extracted in this way. The respective addition values are set in advance in the suitability evaluation data.

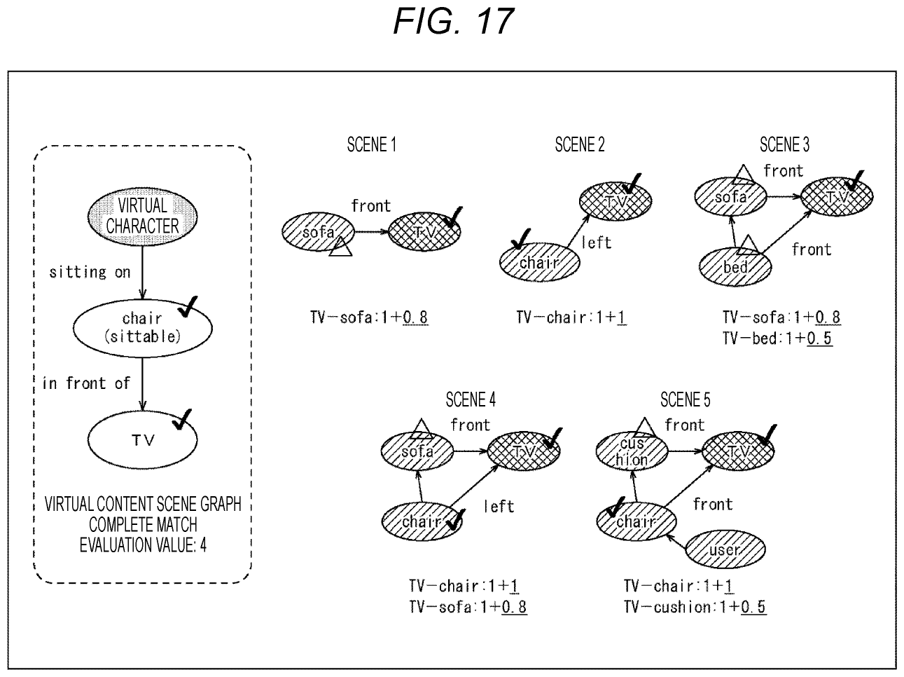

FIG. 17 is a diagram illustrating an example of evaluation as to whether a chair node is included in the scene graph.

### Scene 1

Although no chair node is included, a sofa node that is an object in a category having the same superordinate concept as the chair is included as indicated by a triangle mark. A value of “0.8” is added to the node matching evaluation value Cₙ of the television-sofa node candidate set of Scene 1.

### Scene 2

As indicated by a check mark, a chair node is included. A value of “1.0” is added to the node matching evaluation value Cₙ of the television-chair node candidate set of Scene 2.

### Scene 3

Although no chair node is included, a sofa and a bed node, which are objects in a category having the same superordinate concept as the chair, are included as indicated by a triangle mark. A value of “0.8” is added to the node matching evaluation value Cₙ of the television-sofa node candidate set of Scene 3, and a value of “0.5” is added to the node matching evaluation value Cₙ of the television-bed node candidate set.

### Scene 4

As indicated by a check mark, a chair node is included. In addition, as indicated by a triangle mark, a node of a sofa which is an object of a category having the same superordinate concept as a chair is included. A value of “1.0” is added to the node matching evaluation value Cₙ of the television-chair node candidate set of Scene 4, and a value of “0.8” is added to the node matching evaluation value Cₙ of the television-sofa node candidate set.

### Scene 5

As indicated by a check mark, a chair node is included. In addition, as indicated by a triangle mark, a node of a cushion which is an object having the same attribute as the chair is included. A value of “1.0” is added to the node matching evaluation value Cₙ of the television-chair node candidate set of Scene 5, and a value of “0.5” is added to the node matching evaluation value Cₙ of the television-cushion node candidate set.

The node suitability evaluation value is calculated as described above for the node candidate set of each scene.

### <Example of Edge Suitability Evaluation>

In the edge suitability evaluation (step S22 in FIG. 10), whether the label “front” is set to the edge connecting the nodes constituting the node candidate set (whether there is a “front” relationship between the nodes constituting the node candidate set) is evaluated.

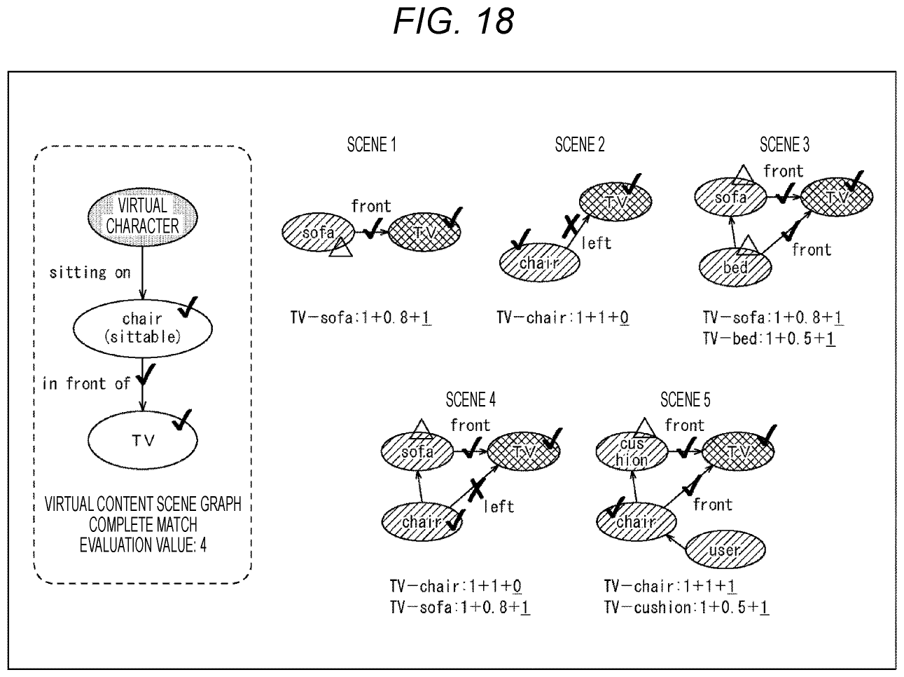

FIG. 18 is a diagram illustrating an example of evaluation as to whether the label “front” is set.

### Scene 1

As indicated by a check mark, a label “front” is set on an edge connecting the node of the television and the node of the sofa. A value of “1.0” is added to the edge matching evaluation value Cₑ of the television-sofa node candidate set of Scene 1.

### Scene 2

As indicated by a cross mark, a label “left” is set at an edge connecting the node of the television and the node of the chair. No addition is performed on the edge matching evaluation value Cₑ of the television-chair node candidate set of Scene 2.

### Scene 3

As indicated by a check mark, a label “front” is set on an edge connecting the node of the television and the node of the sofa. In addition, a label “front” is set on an edge connecting the node of the television and the node of the bed. A value of “1.0” is added to the edge matching evaluation value Cₑ of the television-sofa node candidate set of Scene 3. A value of “1.0” is added to the edge matching evaluation value Cₑ of the television-bed node candidate set.

### Scene 4

As indicated by a check mark, a label “front” is set on an edge connecting the node of the television and the node of the sofa. In addition, as indicated by a cross mark, a label “left” is set at an edge connecting the node of the television and the node of the chair. No addition is performed on the edge matching evaluation value Cₑ of the television-chair node candidate set of Scene 4. A value of “1.0” is added to the edge matching evaluation value Cₑ of the television-sofa node candidate set.

### Scene 5

As indicated by a check mark, a label “front” is set at an edge connecting the node of the television and the node of the cushion. In addition, a label “front” is set to an edge connecting the node of the television and the node of the chair. A value of “1.0” is added to the edge matching evaluation value Cₑ of the television-chair node candidate set of Scene 5. A value of “1.0” is added to the edge matching evaluation value Cₑ of the television-cushion node candidate set.

In this manner, no point is added to the node candidate sets of the scenes 2 and 4 in which the “front” relationship is not included between the node of the television and the node of the chair, and the edge matching evaluation value is lowered.

### <Attribute Suitability Evaluation>

In the attribute suitability evaluation (step S23 in FIG. 10), it is evaluated whether or not the attribute of “sittable” is set in the node of the chair constituting the node candidate set or the node of the object similar to the chair. Here, nodes of a sofa, a bed, and a cushion are also evaluated as nodes in which an attribute of “sittable” is set. On the other hand, the chair on which the user is sitting is evaluated as a node in which an attribute of “sittable” is not set.

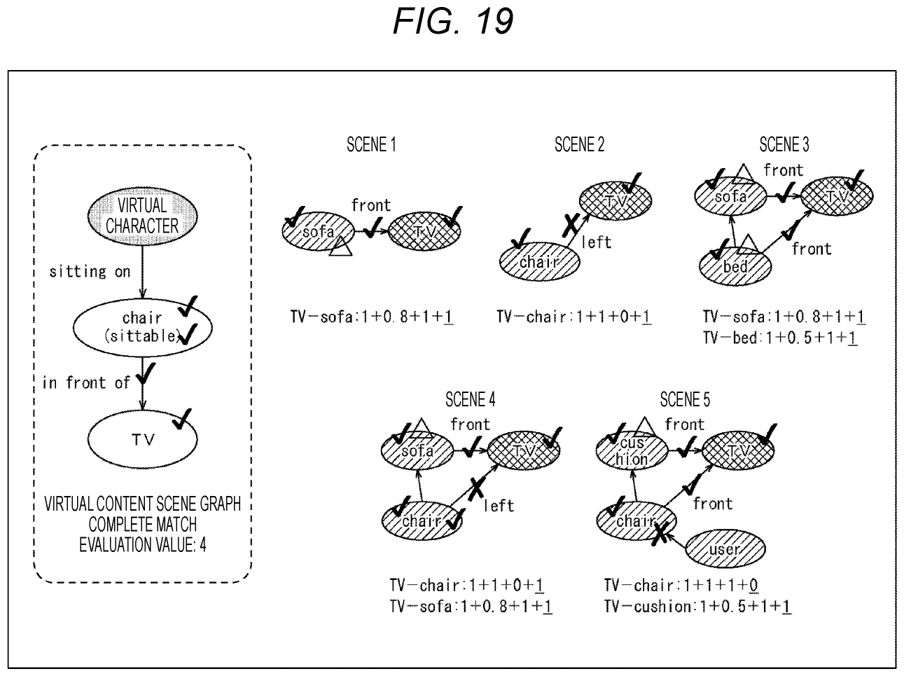

FIG. 19 is a diagram illustrating an example of evaluation as to whether or not the attribute “sittable” is set.

### Scene 1

As indicated by a check mark, a node of a sofa in which an attribute of “sittable” is set is included. A value of “1.0” is added to the attribute matching evaluation value Cₐ of the television-sofa node candidate set of Scene 1.

### Scene 2

As indicated by a check mark, a node of a chair in which an attribute “sittable” is set is included. A value of “1.0” is added to the attribute matching evaluation value Cₐ of the television-chair node candidate set in Scene 2.

### Scene 3

As indicated by a check mark, a node of a sofa and a node of a bed in which an attribute of “sittable” is set are included. A value of “1.0” is added to the attribute matching evaluation value Cₐ of the television-sofa node candidate set of Scene 3. A value of “1.0” is added to the attribute matching evaluation value Cₐ of the television-bed node candidate set.

### Scene 4

As indicated by a check mark, a node of a sofa and a node of a chair in which an attribute of “sittable” is set are included. A value of “1.0” is added to the attribute matching evaluation value Cₐ of the television-chair node candidate set in Scene 4. A value of “1.0” is added to the attribute matching evaluation value Cₐ of the television-sofa node candidate set.

### Scene 5

As indicated by a check mark, a node of a cushion in which an attribute “sittable” is set is included. Furthermore, as indicated by a cross mark, a node of a chair in which an attribute of “sittable” is not set because the user is sitting is included. No addition is performed on the attribute matching evaluation value Cₐ of the television-chair node candidate set of Scene 5. A value of “1.0” is added to the attribute matching evaluation value Cₐ of the television-cushion node candidate set.

### <Example of Context Suitability Evaluation>

The context suitability of the node candidate set of each scene is calculated on the basis of the sum value (evaluation value) obtained by the weighted sum of the node matching evaluation value Cₙ, the edge matching evaluation value Cₑ, and the attribute matching evaluation value Cₐ (step S24 in FIG. 10). The context suitability is calculated as the ratio of the calculated sum value to “4.0” (FIG. 12) which is the sum value of the evaluation values when the contexts completely match.

As described above, the weight of each of the node matching evaluation value Cₙ, the edge matching evaluation value Cₑ, and the attribute matching evaluation value Cₐ is “1.0”.

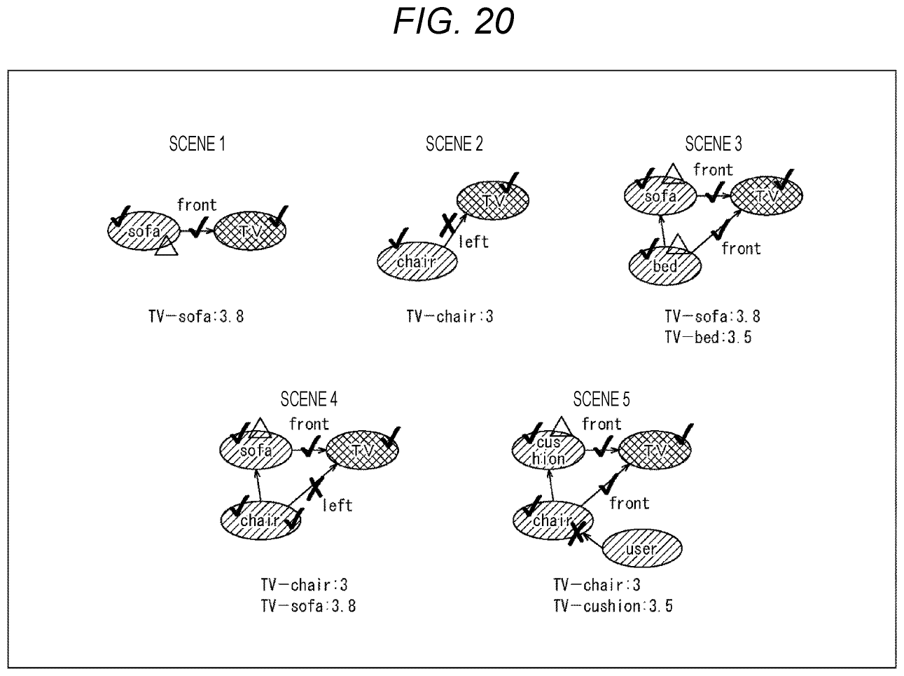

FIG. 20 is a diagram illustrating an example of an evaluation value of a node candidate set of each scene.

### Scene 1

The evaluation value of the television-sofa node candidate set is calculated as “3.8”.

In addition, the context suitability of the television-sofa node candidate set is calculated as “3.8/4.0” (%).

### Scene 2

The evaluation value of the television-chair node candidate set is calculated as “3.0”.

Further, the context suitability of the television-chair node candidate set is calculated as “3.0/4.0” (%).

### Scene 3

The evaluation value of the television-sofa node candidate set is calculated as “3.8”. The evaluation value of the television-bed node candidate set is calculated as “3.5”.

In addition, the context suitability of the television-sofa node candidate set is calculated as “3.8/4.0” (%). The context suitability of the television-bed node candidate set is calculated as “3.5/4.0” (%).

### Scene 4

The evaluation value of the television-chair node candidate set is calculated as “3.0”. The evaluation value of the television-sofa node candidate set is calculated as “3.8”.

Further, the context suitability of the television-chair node candidate set is calculated as “3.0/4.0” (%). The context suitability of the television-sofa node candidate set is calculated as “3.8/4.0” (%).

### Scene 5

The evaluation value of the television-chair node candidate set is calculated as “3.0”. The evaluation value of the television-cushion node candidate set is calculated as “3.5”.

Further, the context suitability of the television-chair node candidate set is calculated as “3.0/4.0” (%). The context suitability of the television-cushion node candidate set is calculated as “3.5/4.0” (%).

### <Example of Mapping Possibility Determination>

Mapping possibility determination is performed by comparing the context suitability calculated as described above with the allowable suitability.

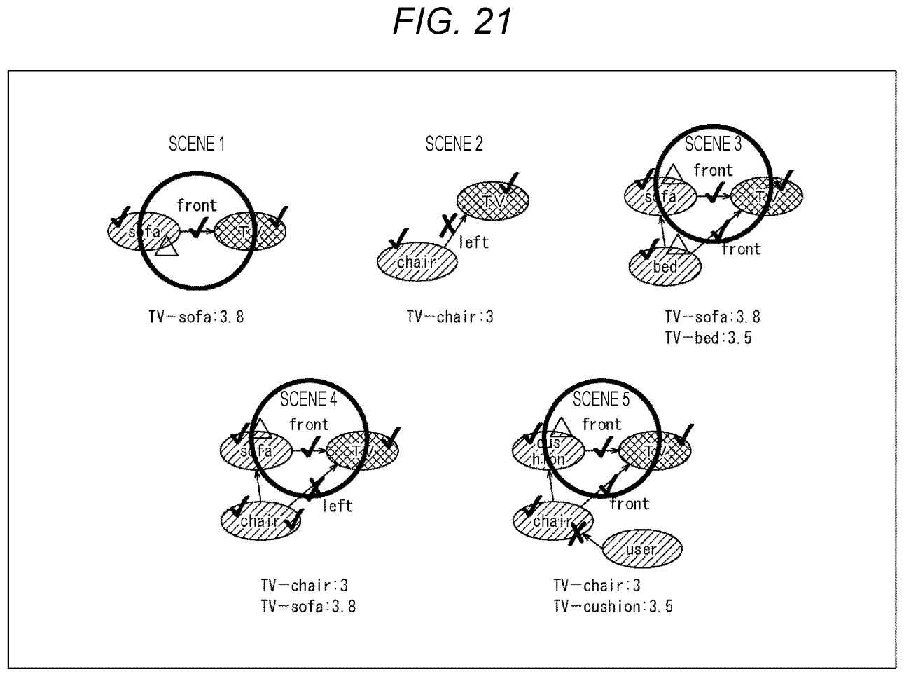

When the allowable suitability is set to 80%, the television-sofa node candidate set in Scene 1 for which the context suitability of “3.8/4.0” has been calculated is determined to be mappable, as illustrated by enclosing the set with a circle in FIG. 21.

It is also determined that the television-sofa node candidate set in Scene 3, the television-sofa node candidate set in Scene 4, and the television-cushion node candidate set in Scene 5 are mappable.

When there is a plurality of node candidate sets determined to be mappable as in Scene 3, mapping of virtual objects is performed using an object (sofa) corresponding to a node constituting a node candidate set having a higher context suitability.

The virtual objects included in the virtual content created assuming the context as illustrated in FIG. 12 are determined to be mappable not only when the contexts are completely matched but also when spaces having similar contexts such as Scene 1, Scene 3, Scene 4, and Scene 5 are set as the user experience space.

In this way, the context suitability evaluation of the user experience space enables flexible mapping of objects.

### <<Presentation of Method for Improving Context>>

When it is determined that mapping of the virtual object is impossible, a context improvement method is presented (step S8 in FIG. 5). The presentation of the improvement method is performed using, for example, the HMD 1 worn by the user. The presentation of the improvement method may be performed using another interface such as a display of a smartphone carried by the user.

Unless the user sufficiently understands the context required for mapping the virtual objects in advance, it is difficult to grasp how to change the layout of furniture or the like to satisfy the required context. Typically, there is a difference between the context of the user experience space and the context assumed by the virtual content.

The user can bring the context of the user experience space closer to the context in which the virtual object can be mapped by changing the layout of the furniture or the like according to the presentation.

### First Presentation Example

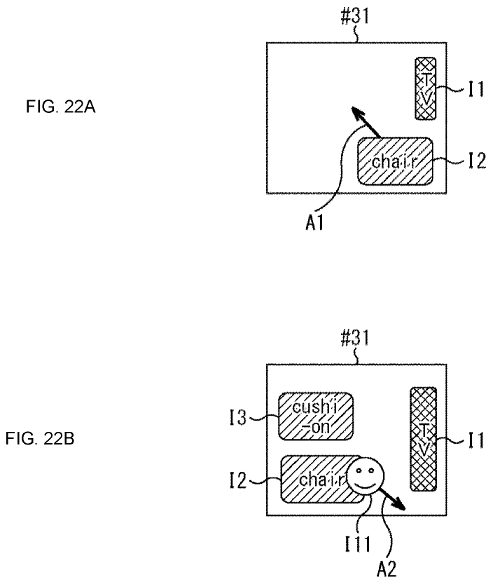

FIG. 22 is a diagram illustrating a presentation example of an improvement method.

A of FIG. 22 illustrates a first presentation example. A rectangle #31 in A of FIG. 22 represents a user experience space. The presence of the television and the chair in the user experience space is displayed by icons I1 and I2 representing the respective objects. The chair is located beside the television. These pieces of information are displayed on the basis of a three-dimensional map or a scene graph of the user experience space.

In this case, the arrow A1 indicating that the chair is moved to the front of the television together with the information such as the icons I1 and I2 is presented as the information regarding the method for improving the user experience space.

When the context of the user experience space is in the state illustrated in A of FIG. 22, since the chair is not in front of the television, the virtual content in the scenario “A virtual character sits on a chair that is in front of a television and on which the virtual character can sit.” is determined as unable to be mapped. By moving the chair in front of the television while viewing the display of the arrow A1, the user can bring the context of the user experience space closer to the context of the space assumed by the virtual content.

In the context suitability evaluation after the chair is moved to the front of the television, it is determined that the mapping of the virtual object is possible, and the image of the virtual character sitting on the chair in front of the television is displayed.

In this way, information for guiding the object in the user experience space to move to a position where a higher context suitability is expected to be calculated is presented as a context improvement method. In the example of A of FIG. 22, the chair that has been guided to move the arrangement position is a real object corresponding to a node constituting a scene graph of the user experience space.

### Second Presentation Example

B of FIG. 22 illustrates a second presentation example. Description overlapping with the above description will be appropriately omitted. The presence of the television, the chair, and the cushion in the user experience space is displayed by icons I1, I2, and I3 representing the respective objects. In addition, an icon I11 displayed to be partially superimposed on the icon I3 presents that the user is sitting on the chair.

In this case, the arrow A2 that prompts the user to move from the chair is presented as the information regarding the method for improving the user experience space.

When the context of the user experience space is in the state illustrated in B of FIG. 22, since the user is sitting on a chair, the virtual content in the scenario of “A virtual character sits on a chair that is in front of a television and on which the virtual character can sit.” is determined as unable to be mapped. The user stands up from the chair and moves while viewing the display of the arrow A2, so that the context of the user experience space can be brought closer to the context of the space assumed by the virtual content.

In the context suitability evaluation after moving from the chair, it is determined that the mapping of the virtual object is possible, and the image of the virtual character sitting on the chair in front of the television is displayed.

In this way, information for guiding change of the situation of the object in the user experience space to a situation in which a higher context suitability is expected to be calculated is presented as a context improvement method. In the example of B of FIG. 22, the guidance for prompting the user to move is guidance for changing a situation in which the virtual character cannot sit to a situation in which the virtual character can sit.

### Third Presentation Example

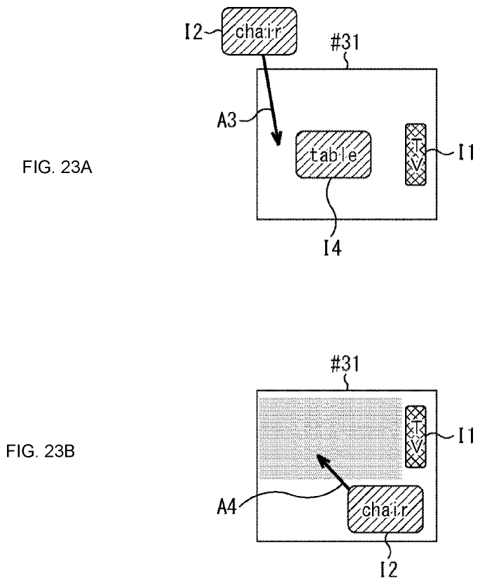

FIG. 23 is a diagram illustrating another presentation example of the improvement method.

A of FIG. 23 illustrates a third presentation example. The presence of the television and the table in the user experience space is displayed by icons I1 and I4 representing the respective objects.

In this case, together with the icon I2 representing the chair, the arrow A3 representing adding the chair to the user experience space is presented as the information regarding the method for improving the user experience space.

When the context of the user experience space is in the state illustrated in A of FIG. 23, since there is no chair, the virtual content in the scenario of “A virtual character sits on a chair that is in front of a television and on which the virtual character can sit.” is determined as unable to be mapped. By viewing the display of the arrow A3 and taking a chair in another room and adding the chair to the user experience space, the user can bring the context of the user experience space closer to the context of the space assumed by the virtual content.

In the context suitability evaluation after adding the chair, it is determined that the mapping of the virtual object is possible, and the image of the virtual character sitting on the chair in front of the television is displayed.

In this way, information that guides addition of an object, such as furniture, to the user experience space, for which a higher context suitability is expected to be calculated, is presented as a context improvement method. In the example of A of FIG. 23, the chair for which the addition is guided is a real object corresponding to a node that is not included in the scene graph of the user experience space.

### Fourth Presentation Example

B of FIG. 23 illustrates a fourth presentation example. The presence of the television and the chair in the user experience space is displayed by icons I1 and I2 representing the respective objects. The chair is located beside the television.

In this case, the area indicating the movement destination of the chair is displayed in a predetermined color, and the arrow A4 indicating that the chair is moved to the colored area is presented as the information regarding the method for improving the user experience space.

When the context of the user experience space is in the state illustrated in B of FIG. 23, since the chair is not in front of the television, the virtual content in the scenario “A virtual character sits on a chair that is in front of a television and on which the virtual character can sit.” is determined as unable to be mapped. By moving the chair in front of the television while viewing the display of the arrow A4, the user can bring the context of the user experience space closer to the context of the space assumed by the virtual content.

In the context suitability evaluation after the chair is moved to the front of the television, it is determined that the mapping of the virtual content is possible, and the image of the virtual character sitting on the chair in front of the television is displayed.

In this manner, information for guiding movement of an object in the user experience space and guiding a movement destination is presented as a context improvement method.

When there is a plurality of methods as improvement methods, a highly effective method is presented on the basis of the result of the context suitability evaluation.

An object to be presented as a target of movement or an additional target may be selected on the basis of characteristics of the object such as weight and size. This makes it possible to prevent occurrence of a situation in which a large object that cannot be moved is guided to the user.

### <<Configuration of Each Device>>

Here, a configuration of each device constituting the information processing system will be described.

### <Configuration of HMD 1>

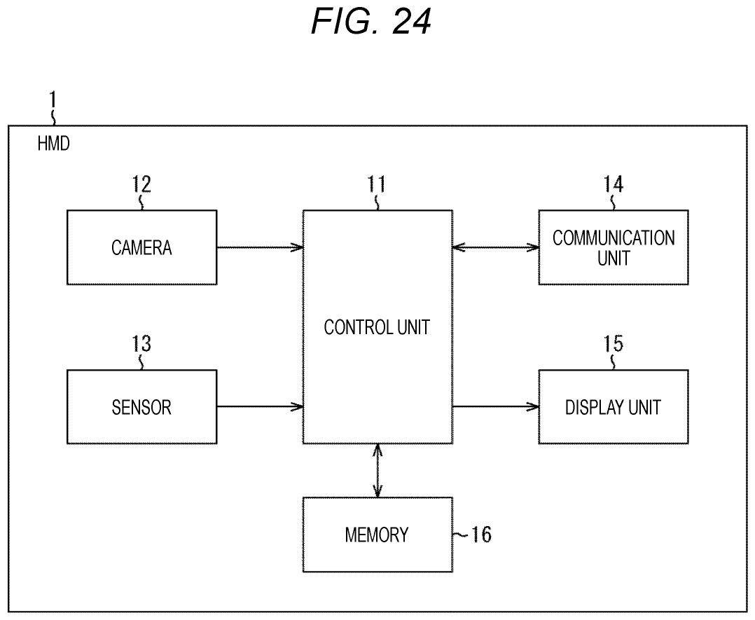

FIG. 24 is a block diagram illustrating a configuration example of the HMD 1.

As illustrated in FIG. 24, the HMD 1 is configured by connecting a camera 12, a sensor 13, a communication unit 14, a display unit 15, and a memory 16 to a control unit 11.

The control unit 11 includes a central processing unit (CPU), a read only memory (ROM), and a random access memory (RAN) or the like. The control unit 11 executes a program stored in the ROM or the memory 16 and controls the entire operation of the HMD 1.

For example, when the measurement of the user experience space is performed by the HMD 1, the control unit 11 controls the communication unit 14 to transmit data such as an RGB image captured by the camera 12 and a measurement result by the sensor 13 to the information processing apparatus 2 as measurement data of the user experience space.

Furthermore, when the image data of the virtual object is transmitted from the information processing apparatus 2 and received by the communication unit 14, the control unit 11 outputs the received image data to the display unit 15 and displays the image of the virtual object.

The camera 12 captures a scenery in front of the user and outputs an RGB image to the control unit 11.

The sensor 13 includes various sensors such as a depth sensor and a distance measuring sensor. The depth sensor and the distance measuring sensor constituting the sensor 13 measure the distance to each position in the user experience space, and output a distance image, point cloud data, and the like to the control unit 11.

The sensor 13 appropriately includes various sensors such as an acceleration sensor, a gyro sensor, and a positioning sensor. In this case, measurement results by the acceleration sensor, the gyro sensor, and the positioning sensor are transmitted to the information processing apparatus 2 as measurement data. The measurement results of the acceleration sensor, the gyro sensor, and the positioning sensor are used to estimate the position, the posture, and the like of the user.

The communication unit 14 includes a communication module such as a wireless LAN. The communication unit 14 communicates with the information processing apparatus 2 via the network 3, and transmits data supplied from the control unit 11 to the information processing apparatus 2. Furthermore, the communication unit 14 receives the image data transmitted from the information processing apparatus 2 and outputs the image data to the control unit 11.

The display unit 15 displays the image of the virtual object on the basis of the image data supplied from the control unit 11.

The memory 16 is a storage medium such as a flash memory. The memory 16 stores various data such as a program executed by the CPU of the control unit 11.

### <Configuration of Information Processing Apparatus 2>

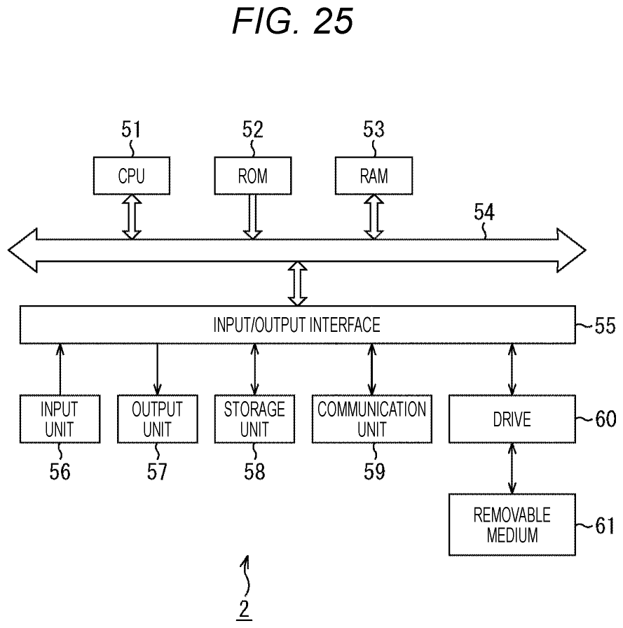

FIG. 25 is a block diagram illustrating a configuration example of the information processing apparatus 2.

A CPU 51, a ROM 52, and a RAM 53 are connected to one another by a bus 54.

An input/output interface 55 is further connected to the bus 54. An input unit 56 including such as a keyboard and a mouse, and an output unit 57 including such as a display and a speaker are connected to the input/output interface 55. A storage unit 58 including such as a hard disk and a non-volatile memory, a communication unit 59 including such as a network interface, and a drive 60 for driving a removable medium 61 are also connected to the input/output interface 55.

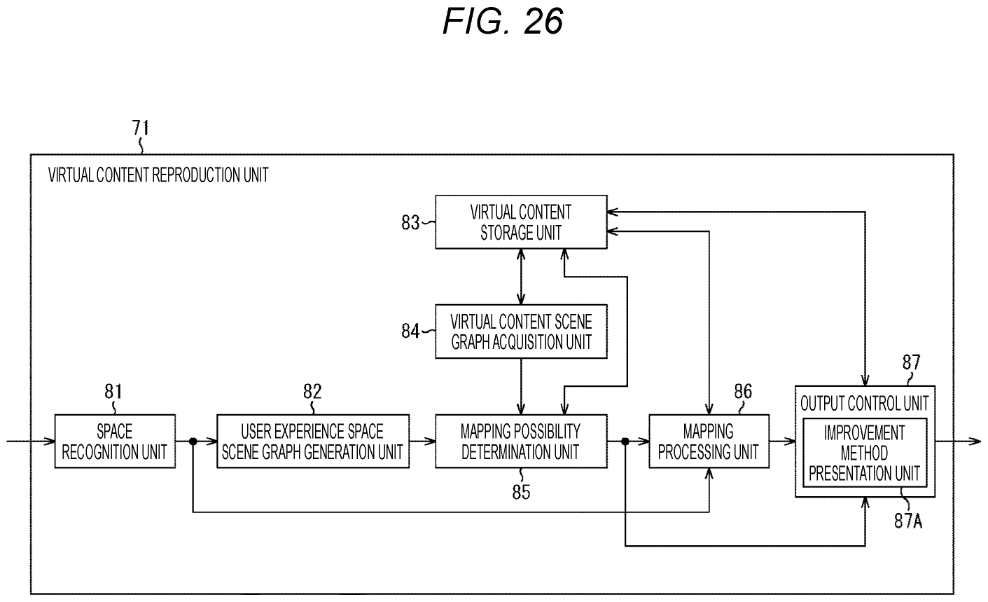

FIG. 26 is a block diagram illustrating a functional configuration example of the information processing apparatus 2.

In the information processing apparatus 2, a predetermined program is executed by the CPU 51 in FIG. 25 to implement a virtual content reproduction unit 71. The virtual content reproduction unit 71 includes a space recognition unit 81, a user experience space scene graph generation unit 82, a virtual content storage unit 83, a virtual content scene graph acquisition unit 84, a mapping possibility determination unit 85, a mapping processing unit 86, and an output control unit 87. The output control unit 87 includes an improvement method presentation unit 87A.

The space recognition unit 81 acquires measurement data including an input image representing the user experience space, such as an RGB image and a distance image, and generates a three-dimensional map of the user experience space. The data of the three-dimensional map generated by the space recognition unit 81 is supplied to the user experience space scene graph generation unit 82 and the mapping processing unit 86. The processing in step S1 in FIG. 5 is processing performed by the space recognition unit 81.

The user experience space scene graph generation unit 82 generates a scene graph of the user experience space on the basis of the three-dimensional map generated by the space recognition unit 81. The user experience space scene graph generation unit 82 functions as an acquisition unit that generates and acquires a scene graph of the user experience space.

The scene graph of the user experience space acquired by the user experience space scene graph generation unit 82 is supplied to the mapping possibility determination unit 85. The processing in step S2 in FIG. 5 is processing performed by the user experience space scene graph generation unit 82.

The virtual content storage unit 83 stores the virtual content data group of FIG. 6.

The virtual content scene graph acquisition unit 84 reads and acquires the scene graph of the virtual space from the virtual content storage unit 83. The virtual content scene graph acquisition unit 84 functions as an acquisition unit that acquires a scene graph of a virtual space prepared as a template.

The data of the scene graph of the virtual space acquired by the virtual content scene graph acquisition unit 84 is supplied to the mapping possibility determination unit 85. The processing in step S3 in FIG. 5 is processing performed by the virtual content scene graph acquisition unit 84.

The mapping possibility determination unit 85 performs the context suitability evaluation processing with reference to the virtual content data group of the virtual content storage unit 83, and determines whether or not the mapping of the virtual object is possible. The mapping possibility determination unit 85 functions as a determination unit that determines a suitability between a node candidate set that is a combination of nodes extracted from the scene graph of the user experience space and a combination of nodes constituting the scene graph of the virtual space.

The determination result by the mapping possibility determination unit 85 is supplied to the mapping processing unit 86 and the output control unit 87 together with information such as the context suitability. The processing in steps S4 and S5 in FIG. 5 is processing performed by the mapping possibility determination unit 85.

The mapping processing unit 86 maps a virtual object. The mapping of the virtual object is performed on the basis of the three-dimensional map generated by the space recognition unit 81, the object data stored in the virtual content storage unit 83, the context suitability calculated by the mapping possibility determination unit 85, and the like. The processing in step S6 in FIG. 5 is processing performed by the mapping processing unit 86.

The output control unit 87 controls output of the image of the virtual object in the HMD 1. The processing in step S7 in FIG. 5 is processing performed by the output control unit 87.

When it is determined that mapping of the virtual object is impossible, the improvement method presentation unit 87A controls display of information that presents a method of improving the context of the user experience space. The processing in step S8 in FIG. 5 is processing performed by the improvement method presentation unit 87A.

In this manner, the output control unit 87 performs the arrangement control of outputting the image of the mapped virtual object and the display control of the information presenting the context improvement method on the basis of the result of the context suitability evaluation. The image of the virtual object and the information presenting the context improvement method are outputs having different contents.

### Modifications

### Configuration Example of Information Processing System

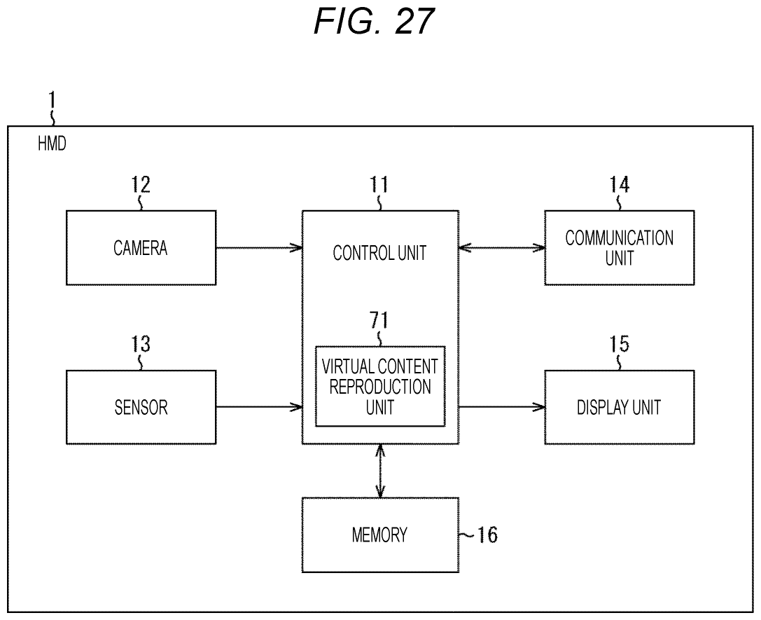

FIG. 27 is a block diagram illustrating another configuration example of the HMD 1.

In the example of FIG. 27, the function of the virtual content reproduction unit 71 is realized in the HMD 1. In this case, the processing described with reference to FIG. 5 and the like is performed in the HMD 1, and the reproduction of the virtual content is performed by the HMD 1 alone.

All the functions of the virtual content reproduction unit 71 may not be realized in the HMD 1, and at least some of the functions of the configuration of the virtual content reproduction unit 71 may be realized in the HMD 1. In this manner, the function of the virtual content reproduction unit 71 can be mounted on the HMD 1.

The scene graph of the user experience space may be generated by an external device. In this case, the context suitability evaluation is performed in the HMD 1 by using the scene graph of the user experience space acquired from the external device.

### Example of Context Suitability

Although the context suitability is calculated on the basis of the three suitabilities of the node suitability calculated by the node suitability evaluation, the edge suitability calculated by the edge suitability evaluation, and the attribute suitability calculated by the attribute suitability evaluation, the context suitability may be calculated on the basis of at least one of the suitabilities instead of using all the three suitabilities.

### Stop Image of Virtual Object

The mapping of the virtual object and the output of the image may be stopped when the context of the user experience space is changed after the start of the display of the image of the virtual object and the context suitability becomes less than the allowable suitability. The mapping of the virtual object and the output of the image are stopped, for example, when the context suitability is calculated as a third suitability lower than the second suitability at which the presentation of the context improvement method is performed.

In this manner, the context suitability evaluation is repeatedly performed even after the start of the display of the image of the virtual object.

### Example of Presentation of Improvement Method

Although the context improvement method is presented when it is determined that the mapping of the virtual object is impossible, the context improvement method may be presented as reference information for preparation of the user experience space before the mapping possibility determination is performed. The user makes preparations such as changing the layout of the furniture according to the improvement method presented as reference information, and brings the context of the user experience space closer to the context assumed by the virtual content.

The presentation of the improvement method may be performed using a voice. In this case, a voice representing the content of the improvement method is output from the speaker provided in the HMD 1.

### About Program

The series of processing described above can be executed by hardware or can be executed by software. When the series of processing is executed by software, a program that constitute the software is installed to a computer incorporated in dedicated hardware, a general-purpose personal computer, or the like.

The program to be installed is provided by being recorded in the removable medium 61 illustrated in FIG. 25 configured with an optical disk (a compact disc-read only memory (CD-ROM), a digital versatile disc (DVD), or the like), a semiconductor memory, or the like. Furthermore, the program may be provided via a wired or wireless transmission medium such as a local area network, the Internet, or digital broadcasting. The program can be installed in the ROM 52 or the storage unit 58 in advance.

The program executed by the computer may be a program in which processing is performed in time series in the order described in the present specification, or may be a program in which processing is performed in parallel or at necessary timing such as when a call is made or the like.

In the present specification, a system is intended to mean assembly of a plurality of components (devices, modules (parts), and the like) and it does not matter whether or not all the components are in the same housing. Therefore, a plurality of devices housed in separate housings and connected via a network and one device in which a plurality of modules is housed in one housing are both systems.

The effects described in the present specification are merely examples and are not limited, and other effects may be provided.

Embodiments of the present technology are not limited to the above-described embodiments, and various modifications may be made without departing from the spirit of the present technology.

For example, the present technology may be configured as cloud computing in which a function is shared by a plurality of devices through the network to process together.

Furthermore, each step described in the above described flowcharts may be performed by one device or by a plurality of devices in a shared manner.

Moreover, when a plurality of processing is included in one step, the plurality of processing included in the one step can be executed by a single device or shared and executed by a plurality of devices.

### Combination Examples of Configurations

The present technology may also have the following configurations.

(1)

A display control device including:
a real space graph acquisition unit that acquires a real space graph that is data of a graph structure including a plurality of real space nodes representing each of a plurality of real objects existing in a real space and a real space edge representing an arrangement relationship of the real objects in the real space;
a template graph acquisition unit that acquires a template graph that is data of a graph structure including a plurality of template nodes representing each of a plurality of template objects that are virtual objects and a template edge representing an arrangement relationship of the template objects;
a determination unit that determines a suitability between a first combination of the plurality of real space nodes and the real space edge and a second combination of the plurality of template nodes and the template edge; and
an output control unit that controls output of an output device to perform arrangement control of arranging a virtual object on the real space when the suitability is a first suitability, and to perform display control related to arrangement of the virtual object different from output by the arrangement control when the suitability is a second suitability lower than the first suitability.
   (2)

The display control device according to (1),
in which the determination unit determines the suitability indicating a degree of matching between context of the real space represented by the first combination and context of a virtual space represented by the second combination.
   (3)

The display control device according to (1) or (2),
in which the determination unit determines the suitability with the second combination for the first combination including the real space nodes same as or similar to the template nodes.
   (4)

The display control device according to any one of (1) to (3),
in which the determination unit determines the suitability on the basis of at least one of a node suitability according to a degree of matching between categories of the real space nodes and the template nodes, an edge suitability according to a degree of matching between the real space edge and the template edge, or an attribute suitability according to a degree of matching between attributes of the real space nodes and the template nodes.
   (5)

The display control device according to (4),
in which the determination unit determines, as the suitability, a ratio of an evaluation value calculated on the basis of the node suitability, the edge suitability, and the attribute suitability to an evaluation value when the first combination matches the second combination, and compares the ratio with an allowable suitability set as a threshold.
   (6)

The display control device according to any one of (1) to (5), in which the output control unit displays, as the display control, information for guiding change of an arrangement position of the real objects corresponding to the real space nodes constituting the first combination to a position where the suitability higher than the second suitability is calculated.

(7)

The display control device according to any one of (1) to (5),
in which the output control unit displays, as the display control, information for guiding addition of the real objects corresponding to the real space nodes not in the first combination to the real space.
   (8)

The display control device according to any one of (1) to (5),
in which the output control unit displays, as the display control, information for guiding change of a situation of the real objects corresponding to the real space nodes constituting the first combination to a situation in which the suitability higher than the second suitability is calculated.
   (9)

The display control device according to any one of (1) to (8),
in which the output control unit stops the arrangement control when the suitability becomes a third suitability lower than the second suitability.
   (10)

The display control device according to any one of (1) to (9),
in which the output control unit arranges, as the arrangement control of the virtual object, a virtual character that performs an action using the real objects corresponding to the real space nodes constituting the first combination.
   (11)

The display control device according to any one of (1) to (10),
in which the real objects are furniture existing in the real space.
   (12)

The display control device according to any one of (1) to (11),
in which the real space edge is information indicating at least one of a position, a posture, a distance, or an angle of the real objects in the real space.
   (13)

The display control device according to any one of (1) to (12),
in which the output control unit controls an output of a head mounted display which is the output device external worn by the user.
   (14)

The display control device according to any one of (1) to (13),
in which the output control unit controls an output of the output device on which the display control device is mounted.
   (15)

The display control device according to any one of (1) to (14),
in which the real space graph acquisition unit acquires the real space graph on the basis of an input image representing the real space.
   (16)

A display control method in which a display control device performs:
acquiring a real space graph that is data of a graph structure including a plurality of real space nodes representing each of a plurality of real objects existing in a real space and a real space edge representing an arrangement relationship of the real objects in the real space;
acquiring a template graph that is data of a graph structure including a plurality of template nodes representing each of a plurality of template objects that are virtual objects and a template edge representing an arrangement relationship of the template objects;
determining a suitability between a first combination of the plurality of real space nodes and the real space edge and a second combination of the plurality of template nodes and the template edge; and
controlling output of an output device to perform arrangement control of arranging a virtual object on the real space when the suitability is a first suitability, and to perform display control related to arrangement of the virtual object different from output by the arrangement control when the suitability is a second suitability lower than the first suitability.
   (17)

A program for causing a computer to perform processing of:
acquiring a real space graph that is data of a graph structure including a plurality of real space nodes representing each of a plurality of real objects existing in a real space and a real space edge representing an arrangement relationship of the real objects in the real space;
acquiring a template graph that is data of a graph structure including a plurality of template nodes representing each of a plurality of template objects that are virtual objects and a template edge representing an arrangement relationship of the template objects;
determining a suitability between a first combination of the plurality of real space nodes and the real space edge and a second combination of the plurality of template nodes and the template edge; and
controlling output of an output device to perform arrangement control of arranging a virtual object on the real space when the suitability is a first suitability, and to perform display control related to arrangement of the virtual object different from output by the arrangement control when the suitability is a second suitability lower than the first suitability.

### REFERENCE SIGNS LIST

1 HMD
2 Information processing apparatus
3 Network
11 Control unit
15 Display unit
71 Virtual content reproduction unit
81 Space recognition unit
82 User experience space scene graph generation unit
83 Virtual content storage unit
84 Virtual content scene graph acquisition unit
85 Mapping possibility determination unit
86 Mapping processing unit
87 Output control unit
87A Improvement method presentation unit

1. A display control device comprising:
a real space graph acquisition unit that acquires a real space graph that is data of a graph structure including a plurality of real space nodes representing each of a plurality of real objects existing in a real space and a real space edge representing an arrangement relationship of the real objects in the real space;
a template graph acquisition unit that acquires a template graph that is data of a graph structure including a plurality of template nodes representing each of a plurality of template objects that are virtual objects and a template edge representing an arrangement relationship of the template objects;
a determination unit that determines a suitability between a first combination of the plurality of real space nodes and the real space edge and a second combination of the plurality of template nodes and the template edge; and
an output control unit that controls output of an output device to perform arrangement control of arranging a virtual object on the real space when the suitability is a first suitability, and to perform display control related to arrangement of the virtual object different from output by the arrangement control when the suitability is a second suitability lower than the first suitability.

2. The display control device according to claim 1,
wherein the determination unit determines the suitability indicating a degree of matching between context of the real space represented by the first combination and context of a virtual space represented by the second combination.

3. The display control device according to claim 1,
wherein the determination unit determines the suitability with the second combination for the first combination including the real space nodes same as or similar to the template nodes.

4. The display control device according to claim 1,
wherein the determination unit determines the suitability on a basis of at least one of a node suitability according to a degree of matching between categories of the real space nodes and the template nodes, an edge suitability according to a degree of matching between the real space edge and the template edge, or an attribute suitability according to a degree of matching between attributes of the real space nodes and the template nodes.

5. The display control device according to claim 4,
wherein the determination unit determines, as the suitability, a ratio of an evaluation value calculated on a basis of the node suitability, the edge suitability, and the attribute suitability to an evaluation value when the first combination matches the second combination, and compares the ratio with an allowable suitability set as a threshold.

6. The display control device according to claim 1,
wherein the output control unit displays, as the display control, information for guiding change of an arrangement position of the real objects corresponding to the real space nodes constituting the first combination to a position where the suitability higher than the second suitability is calculated.

7. The display control device according to claim 1,
wherein the output control unit displays, as the display control, information for guiding addition of the real objects corresponding to the real space nodes not in the first combination to the real space.

8. The display control device according to claim 1,
wherein the output control unit displays, as the display control, information for guiding change of a situation of the real objects corresponding to the real space nodes constituting the first combination to a situation in which the suitability higher than the second suitability is calculated.

9. The display control device according to claim 1,
wherein the output control unit stops the arrangement control when the suitability becomes a third suitability lower than the second suitability.

10. The display control device according to claim 1,
wherein the output control unit arranges, as the arrangement control of the virtual object, a virtual character that performs an action using the real objects corresponding to the real space nodes constituting the first combination.

11. The display control device according to claim 1,
wherein the real objects are furniture existing in the real space.

12. The display control device according to claim 1,
wherein the real space edge is information indicating at least one of a position, a posture, a distance, or an angle of the real objects in the real space.

13. The display control device according to claim 1,
wherein the output control unit controls an output of a head mounted display which is the output device external worn by the user.

14. The display control device according to claim 1,
wherein the output control unit controls an output of the output device on which the display control device is mounted.

15. The display control device according to claim 1,
wherein the real space graph acquisition unit acquires the real space graph on a basis of an input image representing the real space.

16. A display control method in which a display control device performs:
acquiring a real space graph that is data of a graph structure including a plurality of real space nodes representing each of a plurality of real objects existing in a real space and a real space edge representing an arrangement relationship of the real objects in the real space;
acquiring a template graph that is data of a graph structure including a plurality of template nodes representing each of a plurality of template objects that are virtual objects and a template edge representing an arrangement relationship of the template objects;
determining a suitability between a first combination of the plurality of real space nodes and the real space edge and a second combination of the plurality of template nodes and the template edge; and
controlling output of an output device to perform arrangement control of arranging a virtual object on the real space when the suitability is a first suitability, and to perform display control related to arrangement of the virtual object different from output by the arrangement control when the suitability is a second suitability lower than the first suitability.

17. A program for causing a computer to perform processing of:
acquiring a real space graph that is data of a graph structure including a plurality of real space nodes representing each of a plurality of real objects existing in a real space and a real space edge representing an arrangement relationship of the real objects in the real space;
acquiring a template graph that is data of a graph structure including a plurality of template nodes representing each of a plurality of template objects that are virtual objects and a template edge representing an arrangement relationship of the template objects;
determining a suitability between a first combination of the plurality of real space nodes and the real space edge and a second combination of the plurality of template nodes and the template edge; and
controlling output of an output device to perform arrangement control of arranging a virtual object on the real space when the suitability is a first suitability, and to perform display control related to arrangement of the virtual object different from output by the arrangement control when the suitability is a second suitability lower than the first suitability.
